(19) United States
(12) Patent Application Publication
(10) Pub. No.: US 2014/0192836 A1
(43) Pub. Date: Jul. 10, 2014

(54) RESONANT DEW POINT MEASURING DEVICE

(71) Applicant: Paul C. Neilson, Denver, CO (US)

(72) Inventor: Paul C. Neilson, Denver, CO (US)

(73) Assignee: FEMTOSCALE, INC., Englewood, CO (US)

(21) Appl. No.: 14/102,418

(22) Filed: Dec. 10, 2013

Related U.S. Application Data
(60) Provisional application No. 61/735,333, filed on Dec. 10, 2012.

(51) Int. Cl. G01N 25/66

(52) U.S. Cl. CPC G01N 25/66
USPC 374/28

(57) ABSTRACT

A dew and/or frost point measurement instrument and related method are disclosed. An electrically actuated micro/nanoscale resonating element is formed over a resonator substrate. A temperature controlled platform is provided in thermal communication with the resonator substrate. A temperature sensing element is provided in thermal communication with the resonating element. A sustaining amplifier stimulates the resonating element to maintain substantially continuous oscillations at one of its mechanical natural frequencies. A control circuitry monitors the resonator frequency, controls the temperature of the resonator substrate accordingly, and interprets a dew or frost point of a gaseous compound of interest.

### CROSS REFERENCE TO RELATED APPLICATION

The present application claims the benefits of U.S. Provisional Application Ser. No. 61/735,333, filed Dec. 10, 2012, entitled “Technique and Instrument for Dew/Frost Point Measurement Using Micro/Nano-Electro-Mechanical Resonators”, which is incorporated herein by this reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract Nos. IIP-1214737 and IIP-1330350, both awarded by the National Science Foundation.

### FIELD

The disclosure relates generally to measurement devices and particularly to resonant measurement devices.

### BACKGROUND

Measurement of trace moisture is needed in different industrial sectors, including semiconductor manufacturing, pure gas supply, atmospheric and climate research, aerospace, petrochemical processing, power generation, air filter and purifier manufacturing, and supply of reference standards for other trace gases. An important application for a sensitive trace moisture measuring device is the measurement of moisture in natural gas. In cold climates, excess water in the gas pipeline can freeze the pipe shut, rendering the pipeline useless until the frozen point can be identified and cleared. Frequent identification of the moisture content of the natural gas out of the well is not only important for avoiding frozen pipes in cold weather but also to ensure that the well/land owners (including the federal and state governments) are paid the right price for the amount of natural gas they sell.

Measuring the amount of water vapor, or humidity, in a gas can be accomplished using humidity and dew point sensors, which can be divided into two major categories. The first category uses a moisture absorbent layer (e.g. porous polymers, porous ceramics, metal oxides, etc.) that responds to changes in humidity in form of changes in dielectric constant, electrical resistance, film stress, or mass. Such sensors are generally easy to fabricate and therefore lower cost, however they suffer from lack of accuracy, especially at low humidity levels, slow response, and poor long-term stability (requiring frequent calibration). Thin films used in such sensors cannot survive harsh corrosive conditions, especially in a natural gas pipeline, and tend to deteriorate fast. The alternative technique is to simply measure dew or frost point by cooling a surface down to the temperature at which dew or frost is formed. This is a much more fundamental and direct measurement technique that does not rely on an absorbing layer, its potential degradation over time, and intrinsic inaccuracy. The chilled-surface technique is one of the most accurate techniques to measure humidity and is widely used in optical chilled-mirror dew-pointers that use an incident beam of light to detect formation of dew or frost. Water or ice on the mirror changes the amplitude of the reflected optical signal. Existing optical methods require a layer of moisture at least a half a wavelength (hundreds of nanometers) thick to be deposited on the surface before the moisture can be detected.

No affordable moisture measurement instruments exist that can be installed at the natural gas wellheads along with other instruments that measure temperature, pressure, flow, etc. Currently moisture measurements in natural gas are performed only at major points of custody transfer using costly instruments that require frequent calibration.

### SUMMARY

Various aspects, embodiments, and configurations of the present disclosure address these and other needs. The present disclosure is directed to the use of a resonator to measure dew or frost point of water and/or other condensable vapors in a gas.

The resonator can be incorporated into a dew or frost point meter that can include a micro/nano-electro-mechanical resonating structure coupled to a temperature controller. The temperature controller can include a thermoelectric or other type of cooler/heater, temperature sensor, and control circuitry. The temperature of the resonating structure can be changed by the temperature controller until a few nanometers thick layer of dew or frost is formed on the resonator surface from the surrounding gases. The added mass resulting from the layer of dew or frost can be detected by the resonator readout circuitry. The resonator circuitry can detect changes in the resonator mechanical resonant frequency, and the temperature at which dew or frost forms. The resonator circuitry can measure, record, and/or transmit the changes in the resonator frequency and the temperature. A sustaining amplifier can actuate the resonator. The alternating electrical voltage provided by a sustaining amplifier initiates and maintains continuous oscillations in the resonator at its mechanical resonant frequency. Thus, some embodiments of this disclosure can provide for a small size high precision dew/frost point measurement instrument that can be used to measure the concentration of condensable gases in a gaseous mixture. A common application would be to measure moisture concentration in industrial gases.

A method and/or instrument can be provided to determine the dew point and/or frost point of a gas. The method and/or instrument can include: an electrically actuated microscale and/or a nanoscale resonating element formed over a resonator substrate; a temperature control device in thermal communication with the resonator substrate to provide a cooled surface for formation of dew and/or frost on the resonating element; a temperature sensing element in thermal communication with the resonating element to sense a temperature of the cooled surface; a sustaining amplifier, in electrical contact with the resonating element, for stimulating the resonating element to maintain substantially continuous oscillations at a mechanical natural frequency and output a waveform proportional to the mechanical natural frequency is; and control circuitry to monitor a frequency of the resonating element. The control circuitry can control the temperature of the cooled surface in response to the monitored frequency. Based on the temperature of the cooled surface and monitored frequency, the control circuitry can determine a dew or frost point of a gaseous compound of interest.

The resonator can be stimulated by an alternating voltage only at its mechanical resonant frequency. The resonating element can comprise a piezoelectric film. A voltage source can apply a voltage across the piezoelectric film. The temperature sensing element can be integrated on the resonator substrate. A direct current voltage is not required to be applied to the resonating element.

The temperature sensing element can include a resistive temperature detector. The resistive temperature detector can include a metallic thin film deposited on a substrate. The resonating element can be substantially free of flexural deformation when oscillating. The resonating element can include a doubly clamped structure resonating in its bulk mode. The resonating element can be a bulk mode resonator. The resonator may not be a flexural mode resonator.

The piezo electric thin film may be sandwiched between two conductive layers. The sustaining amplifier can be integral with the resonating element. The resonating element can use multiple electrically isolated conductive electrodes. The multiple electrically isolated conductive electrodes may be used for actuating oscillations of the resonating element. The electrically isolated conductive electrodes may be used to sense the resonance of the resonating element. The temperature control element can include a thermoelectric cooler/heater. The oscillation frequency of the resonating element can be measured using a digital counter with a precisely timed gate.

The dew and/or frost point measurement instrument may include a battery in electrical communication with the resonating element and with the control circuitry. The battery can enable wireless operation and be rechargeable. A solar panel may be coupled to the rechargeable battery. The solar panel can enable wireless operation.

The dew and/or frost point measurement instrument may include a porous protective layer disposed over the resonator. The porous protective layer may block particulate and contaminants from reaching the resonator. The instrument may be embodied in a sensor head. The sensor head may have a threaded terminal. The threaded terminal may be for engagement with a pressurized gas line. The instrument may have bonded micro-wires. The bonded micro-wires provide electrical contacts. The electrical contacts may be made between metallic pins and electrical signal pads. The electrical signal pads may be formed over the resonator substrate.

Further, the dew and/or frost point measurement instrument may be included in a sensor head. The sensor head may have a metallic mount. The metallic mount may be for thermally coupling the resonating element with a cooling/heating element. The instrument may be included in a sensor head having a sealed metallic plate with electrically insulated metallic feedthroughs

A method can be provided. The method can cool a bulk mode resonating element. The bulk mode resonating element is cooled in the presence of a gas sample. The temperature of the resonating element is monitored during cooling. The resonating element is cooled until a thin layer of dew or frost is formed on the resonating element. A reduction in the oscillation frequency of the resonating element signals formation of a dew or frost. When the reduction in oscillation frequency occurs, a temperature of the resonating element is sensed as a dew or frost point of a gas sample. In this method, the resonator frequency may increase as the resonating element is cooled until the dew or frost is formed. The oscillation frequency can be a resonant frequency of the resonating element. The resonating element can be substantially free of flexural deformation when oscillating.

The method may include terminating the cooling after detection of the dew or frost. The termination of cooling may include reducing a cooling power of the cooling after formation of the dew or frost. Reducing a cooling power may be used to remove the dew or frost. A direct current voltage can be not applied to the resonating element. The cooling may be controlled after detection of the dew or frost. Controlling the cooling may be used to maintain a predetermined thickness of dew or frost on a surface of the resonating element. A maximum resonator frequency may be recorded before the abrupt reduction to define a reference point for dew or frost thickness and/or or for temperature estimation. Furthermore, a bulk mode resonating element may include a piezoelectric thin film. The piezoelectric film may be sandwiched between two conductive layers.

A tangible and nontransient computer readable medium can be provided that includes microprocessor executable instructions. When the instructions are executed by a microprocessor, there may be cooling of a bulk mode resonating element. The bulk mode resonating element is cooled in the presence of a gas sample. The temperature of the resonating element is monitored during cooling. The resonating element is cooled until a thin layer of dew or frost is formed on the resonating element. A reduction in the oscillation frequency of the resonating element signals formation of a dew or frost. When the reduction in oscillation frequency occurs, a temperature of the resonating element is sensed as a dew or frost point of a gas sample.

An assembly including a micro-chip can be provided. The microchip includes chip body. The chip body can have a chip void, an output pad, an input pad, and a bulk mode resonator. The bulk mode resonator is typically positioned in the chip void. The resonator can include an actuation electrode and a sense electrode. The actuation and sense electrodes can be interdigitated. The microchip can include a piezoelectric material. The piezoelectric material may be in electrical communication with the actuation and sense electrodes. The microchip can include an output lead. The output lead may be electrically interconnected to the actuation electrode and the output pad. The microchip can include an input lead. The input lead may be electrically connected to the sense electrode and the input pad. The assembly can include a temperature control device. The temperature control device may be in thermal communication with the microchip. The temperature control device in thermal communication with the microchip may be used to adjust a temperature of the microchip. The temperature of the microchip may be adjusted when the microchip is oscillating.

The microchip may include a resonator that is a piezoelectric resonator. The piezoelectric resonator includes sense and actuation electrodes. The sense and actuation electrodes can comprise gold and/or platinum. The resonator and chip body can include a metal layer. The metal layer can be positioned between an aluminum nitride layer and a silicon substrate. The sense and actuation electrodes can be positioned on the aluminum nitride layer. Further, the micro-chip may contain a resonator that has little, if any, ohmic loss. The resonator can operate in a range of about 20 to about 30 MHz.

The chip body of the assembly can include a ground pad. The chip body can include a resistive temperature detector. The chip body can include one or more resistive temperature readout pads. The temperature readout pads can be electrically interconnected with the resistive temperature detector.

The resistive temperature detector of the assembly can include platinum. The ground pad, the one or more resistive temperature readout pads, the input lead, input pad, output lead and output pad can include gold and/or platinum. The ground pad, the one or more resistive temperature readout pads, the input lead, input pad, output lead and output pad can be positioned on the aluminum nitride layer. The resistive temperature detector can be positioned adjacent to resonator. The resistive temperature detector can be positioned integrated on top of resonator.

The resonator of the assembly can include a metal electrode layer between the layer of aluminum nitride and the actuation and sense electrodes. The metal electrode layer can bond the actuation and sense electrodes to the aluminum nitride layer.

A device can be provided that includes a housing element. The housing element may have interconnected first and second compartments. A sensor element may be contained in the first the compartment. The sensor element may include a chip platform. The chip platform may be positioned between a heat transfer element in thermal contact with a resonator having a vibrational frequency when actuated by a sustaining amplifier; and a circuitry element that may be contained within the second compartment. The circuitry element can control the sustaining amplifier. The circuitry element can control the heat transfer element. The resonator can be in contact with a first atmosphere. The heat transfer element can be in contact with a second atmosphere. The chip platform can substantially prevent mass transfer between the first and second atmospheres. The first and second atmospheres can differ in pressure by no more than about 500 psi. The first atmosphere may have a greater pressure than the second atmosphere. The heat transfer element can have opposing front and back sides. The back side of the heat transfer element can be in thermal contact with housing element. The front side of the heat transfer element can be in thermal contact with a metallic post holding the resonator. The sustaining amplifier can be positioned between the chip platform and heat transfer element. The chip platform can have a plurality of metal pins. Each of the plurality of metal pins can be sealed to the chip platform by a glass seal. Each of the metal pins can be electrically interconnected to the resonator. The first compartment can have an inlet to admit the first atmosphere. One or more porous elements can be positioned in the inlet. The porous elements may allow gas molecules and water molecules to pass through. The porous elements can substantially block particulate contaminants and debris from passing through. The second compartment may contain a display element. The second compartment may contain view window for the display element. The housing can be substantially explosive-proof and/or be metal.

A system, method, or computer-readable medium can be provided that performs cooling. The system, method, or computer-readable medium can cool, at a cooling rate, a resonating element. The resonating element can be in the presence of a gas sample. The system, method, or computer-readable medium can monitor an oscillation frequency of the resonating element and temperature of at least a portion of the resonating element. The system, method, or computer-readable medium can vary the cooling rate of the resonating element based on one or more of the monitored resonant frequency over a current period, a monitored resonant frequency of a prior period, a difference between the monitored resonant frequencies of the current and prior periods, and a temperature of the resonating element. Based on the monitored oscillation frequency, the system, method, or computer-readable medium may determine at least one of a dew and frost point of the gas sample.

The cooling rate selected can be directly proportional to the magnitude of the difference between the monitored resonant frequencies of the current and prior periods. The cooling rate selected can decrease in magnitude as a rate of change of the difference changes over time.

A tangible and nontransient computer readable medium can be provided that includes microprocessor executable instructions that, when executed by the system, method, or computer-readable medium, can perform one or more of the following operations: cooling, at a cooling rate, of a resonating element, in the presence of a gas sample, while monitoring an oscillation frequency of the resonating element and temperature of a portion of the resonating element; varying the cooling rate of the resonating element based on one or more of the monitored resonant frequency over a current period, a monitored resonant frequency of a prior period, a difference between the monitored resonant frequencies of the current and prior periods, and a temperature of the resonating element; and based on the monitored oscillation frequency, possibly determining a dew and/or frost point of the gas sample.

The present disclosure can provide a number of advantages depending on the particular configuration. Compared to conventional dew point meters, the dew point meter can be more accurate, responsive, stable, economical and/or versatile. It can use a microelectromechanical system (MEMS) resonator, acting as a high precision mass balance, coupled with a controlled temperature control device to measure dew point of a gas. The MEMS resonator is capable of weighing as little as a few femto-grams of deposited moisture, or a dew or frost layer as thin a few nanometers to sub-nanometer. Accordingly, the MEMS resonator-based dew point meter can be orders of magnitude faster than an optical-based instrument. The reduced chilling time for the MEMS resonator can allow for faster response to changes in moisture content and reduced power consumption for the temperature control device, thereby permitting a battery/solar powered dew point meter to be employed at the wellhead. Optical methods are also limited in the pressure that they can withstand as the optical components must be protected from any corrosive agents or high pressure by an optically clear high pressure glass. This can add expense, reduce sensitivity and require colder temperatures to deposit the moisture on the chilled surface (i.e., dew point decreases as pressure decreases). By contrast, the dew point meter of this disclosure can have no pressure limitation, thereby allowing the pressure at the sensor to be the same as the line pressure. Running the dew point meter at line pressure can reduce the cooling required to deposit moisture on the chilled surface of the MEMS resonator (i.e., dew-points will be higher). This can further reduce the power needs of the MEMS resonator instrument. Another disadvantage of chilled-mirror instruments is that the optical methods are confused by the accumulation of dirt on the chilled surface and therefore need to be cleaned frequently, making unattended operation impossible. By contrast, the MEMS resonator can employ a self-correcting “taring” technique that will make the dew point meter insensitive to dirt and debris. During each measurement, the MEMS resonator monitors the mass difference (through frequency change) before and after that specific measurement. Any debris present on the resonator before the measurement simply causes a permanent constant shift in the resonant frequency of the resonator and does not affect the frequency difference measurement caused by dew formation. In addition, because the gas sample required to make a measurement can be much smaller than the requirement of the optical method, the possibility of contamination of the sensor can be highly reduced. Such factors can reduce greatly the need for sensor cleaning, maintenance, and calibration allowing unattended operation at the wellheads. Stated simply, the MEMS-based dew point meter can combine the accuracy of the chilled surface dew point measurement technique with robustness, stability, small size, low power consumption, low cost, low maintenance, and fast speed provided by the MEMS resonant balance.

These and other advantages will be apparent from the disclosure of the aspects, embodiments, and configurations contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

The terms “determine”, “calculate” and “compute,” and variations thereof, as used herein, are used interchangeably and include any type of methodology, process, mathematical operation or technique.

The term “dew point” generally refers is the temperature below which the water vapor in air at constant barometric pressure condenses into liquid water at the same rate at which it evaporates. The condensed water is called dew when it forms on a solid surface. The term “dew point” can extended to refer to any gas that condenses to form a dew on a solid surface.

The term “frost point” generally refers to something similar to the dew point, in that it is the temperature to which a given parcel of humid air must be cooled, at constant barometric pressure, for water vapor to be deposited on a surface as ice without going through the liquid phase. The term “frost point” can extended to refer to any gas that condenses to form a solid on a surface.

The term “humidity” generally refers the amount of water vapor in the air. The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “MEMS” generally refers to components between 1 to 100 micrometres in size (i.e. 0.001 to 0.1 mm), and MEMS devices generally range in size from 20 micrometres (20 millionths of a metre) to a millimetre (i.e. 0.02 to 1.0 mm).

The term “microscale” generally refers to working with milligram or smaller quantities of chemical substances, and/or lengths or dimensions on the order of microns (10⁻⁶ meters).

The term “micro/nanoscale” generally refers to working with structures that have dimensions that include or are between the microscale and nanoscale. This would include structures that have line widths and/or other dimensions that are between 1×10⁻⁵ and 1×10⁻¹⁰ meters.

The term “natural gas” can refer to pure methane, or to a mixture of hydrocarbon gas products that may be recovered from a well, consisting primarily of methane, but commonly including varying amounts of other higher alkanes. It sometimes contains a significant amount of ethane, propane, butane, and pentane. Non-hydrocarbons such as water, carbon dioxide, nitrogen, helium (rarely), and hydrogen sulfide may also be mixed in with the natural gas.

The term “nanoscale” generally refers to structures with a length scale applicable to nanotechnology, usually cited as 1-100 nanometers.

The term “module” as used herein refers to any known or later developed hardware, software, firmware, artificial intelligence, fuzzy logic, or combination of hardware and software that is capable of performing the functionality associated with that element.

“Resonance” is the tendency of a system to oscillate with greater amplitude at some frequencies than at others. A frequency at which a response amplitude is a relative maximum are known as a “resonant frequency” or “resonance frequency” of the system.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram depicting a dew point meter according to the present disclosure;

FIG. 2 is a perspective view of a MEMS resonator chip according to the present disclosure;

FIG. 3 is a side cross-sectional view of the MEMS resonator chip of FIG. 2;

FIG. 4A depicts a side cross sectional view of an initial Silicon on Insulator wafer used in the manufacture of the MEMS resonator chip of FIG. 2;

FIG. 4B depicts a side cross sectional view of a chip in an intermediate stage of the manufacture of the MEMS resonator chip of FIG. 2;

FIG. 4C depicts a side cross sectional view of a chip in another intermediate stage of the manufacture of the MEMS resonator chip of FIG. 2;

FIG. 4D depicts a side cross sectional view of a chip in another intermediate stage of the manufacture of the MEMS resonator chip of FIG. 2;

FIG. 4E depicts a side cross sectional view of a chip in another intermediate stage of the manufacture of the MEMS resonator chip of FIG. 2;

FIG. 4F depicts a side cross sectional view of a chip in another intermediate stage of the manufacture of the MEMS resonator chip of FIG. 2;

FIG. 4G depicts a side cross sectional view of a chip in another intermediate stage of the manufacture of the MEMS resonator chip of FIG. 2;

FIG. 4H depicts a side cross sectional view of a chip in another intermediate stage of the manufacture of the MEMS resonator chip of FIG. 2;

FIG. 4I depicts a side cross sectional view of a chip in another intermediate stage of the manufacture of the MEMS resonator chip of FIG. 2;

FIG. 4J depicts a side cross sectional view of a chip in another intermediate stage of the manufacture of the MEMS resonator chip of FIG. 2;

FIG. 4K depicts a side cross sectional view of a chip in another intermediate stage of the manufacture of the MEMS resonator chip of FIG. 2;

FIG. 4L depicts a side cross sectional view of a chip in another intermediate stage of the manufacture of the MEMS resonator chip of FIG. 2;

FIG. 4M depicts a side cross sectional view of a chip in another intermediate stage of the manufacture of the MEMS resonator chip of FIG. 2;

FIG. 4N depicts a side cross sectional view of a chip in another intermediate stage of the manufacture of the MEMS resonator chip of FIG. 2;

FIG. 4O depicts a side cross sectional view of a chip in another intermediate stage of the manufacture of the MEMS resonator chip of FIG. 2;

FIG. 4P depicts a side cross sectional view of a chip in another intermediate stage of the manufacture of the MEMS resonator chip of FIG. 2;

FIG. 5A is the first portion of the flow chart depicting the various steps in manufacturing the MEMS resonator chip of FIG. 2;

FIG. 5B is the second portion of the flow chart depicting the various steps in manufacturing the MEMS resonator chip of FIG. 2;

FIG. 5C is the third portion of the flow chart depicting the various steps in manufacturing the MEMS resonator chip of FIG. 2;

FIG. 5D is the fourth portion of the flow chart depicting the various steps in manufacturing the MEMS resonator chip of FIG. 2;

FIG. 5E is the fifth portion of the flow chart depicting the various steps in manufacturing the MEMS resonator chip of FIG. 2;

FIG. 5F is the sixth portion of the flow chart depicting the various steps in manufacturing the MEMS resonator chip of FIG. 2;

FIG. 5G is the final portion of the flow chart depicting the various steps in manufacturing the MEMS resonator chip of FIG. 2;

FIG. 6 is a side view of a dew point meter according to the present disclosure;

FIG. 7 is a side cross-sectional view of the dew point meter of FIG. 6;

FIG. 8 is a disassembled view of the dew point meter of FIG. 6;

FIG. 9 is a perspective view of a MEMS chip platform according to the present disclosure;

FIG. 10 is a block diagram of a dew point control module according to the present disclosure;

FIG. 11 is a more detailed block diagram of the dew point control module of FIG. 10;

FIG. 12 is a top view of the MEMS resonator chip after application of additional conductive layers;

FIG. 13 is a flow diagram of control logic according to the present disclosure;

FIG. 14 is a flow diagram of a modified form of the control logic of FIG. 13;

FIG. 15 is a detailed top view of the MEMS chip platform of FIG. 9;

FIG. 16 is an SEM view and the measured frequency response of a ˜27 MHz thin film piezoelectric on silicon resonator with an unloaded Q of ˜45,000 in air;

FIG. 17 depicts measured quality factors for two different piezoelectric resonators under high pressure showing quality factor decreasing sharply first and somewhat stabilizing at higher pressures (zero on the horizontal axis indicates atmospheric pressure (˜12.5 psi in Denver, Colo.), therefore absolute pressures are 12.5 psa higher than those shown on the horizontal axis);

FIG. 18 depicts the measured frequency responses for the thermal-piezoresistive resonator under different bias voltages;

FIG. 19 depicts measured resistance values for a fabricated integrated platinum micro-RTD over the temperature range of −65 to +55° showing the desired linear response and a slop of 800 ppm/° C.;

FIG. 20 depicts the measured change in resonance frequency and bias current of a selected MEMS resonator as a result of change in bias voltage;

FIG. 21 depicts a total of 4500 dew point measurement data points with every 500 points performed under somewhat constant sample moisture content (calculated (expected) dew point values along with the average and standard deviation of the 500 data points in each set are also given showing great agreement and consistency in the results);

FIG. 22 depicts measured resonant frequency versus temperature for a piezoelectric MEMSS resonator while exposed to air with various moisture contents (as the resonator cools down its resonant frequency increases until the temperature reaches the dew points of the surrounding air at which point there is a sharp decrease in frequency); and

FIG. 23A depicts a non-exclusive example of interdigitated configurations of one or more actuator electrodes and one or more sense electrodes.

FIG. 23B depicts another non-exclusive example of interdigitated configurations of one or more actuator electrodes and one or more sense electrodes.

FIG. 23C depicts a non-exclusive example of an alternative configuration of an actuator electrode and a sense electrode.

FIG. 23D depicts a non-exclusive example of another alternative configuration of an actuator electrode and a sense electrode.

### DETAILED DESCRIPTION

### Overview of Dew Point Meter

The dew point meter of the present disclosure can use a microelectromechanical system (MEMS) resonator, acting as a highly sensitive and precise mass balance, and a carefully controlled temperature control device to measure dew point. A dew point measurement cycle can include cooling, by the temperature control device, a surface of the MEMS resonator (“the chilled surface”) until dew or frost point in the surrounding gas sample is reached. At that point, a layer of dew or frost, which can be as low as sub-nanometer in thickness, forms on the chilled surface. The layer of dew or frost consequently increases MEMS resonator mass. The MEMS resonator is forced into continuous oscillations using a sustaining amplifier, and the oscillation frequency is measured using a frequency counter (e.g., a digital counter that is read and reset by the control circuitry in precisely controlled time-frames). The increase in the MEMS resonator mass is indicated by a drop in the resonant frequency. The drop in the MEMS resonator oscillation frequency signals formation of dew or frost on the chilled surface. At this point, the chilled surface temperature is sensed to provide an accurate reading of the dew or frost point temperature of the gas sample.

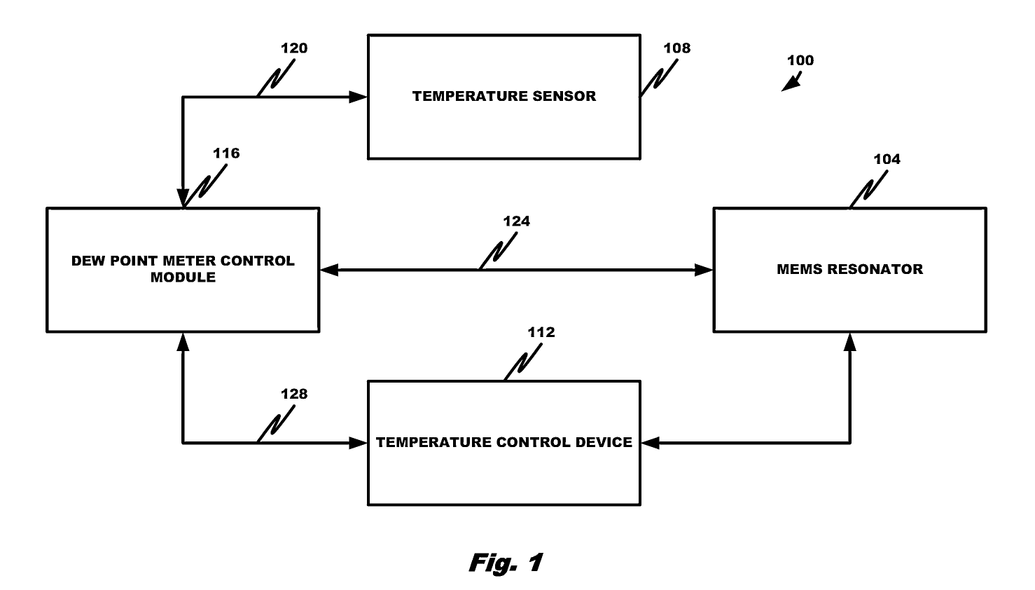

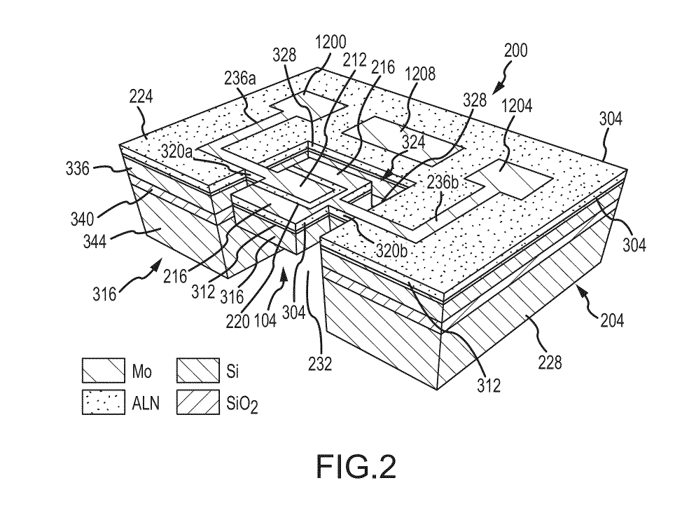

FIG. 1 depicts an embodiment of a dew point meter 100 according to the present disclosure. The dew point meter 100 includes the MEMS resonator 104 (on a MEMS resonator chip 200 (FIG. 2)), the temperature sensor 108, the temperature control device 112, and the dew point meter control module 116 in electrical communication with the other components via control or signaling lines 120, 124, and 128. These components are discussed in detail below. While the resonator is discussed with reference to a micro-scale system, it is to be understood that a nano-scale system may be employed as the resonator.

### The Microelectromechanical System (MEMS) Resonator Chip 200

FIG. 2 depicts MEMS resonator chip 200 comprising a chip body 204 having one or more MEMS resonators 104. Each of the MEMS resonators 104 includes an actuator electrode 212 and a sense electrode(s) 216. The actuator electrode 212 and sense electrode(s) 216 are interdigitated and separated by a gap 220 between the actuator and sense electrode(s) 212 and 216. A resonator output pad 1200 is attached to, and in electrical communication with, the actuator electrode 212. A resonator input pad 1204 is attached to the sense electrode(s) 215a,b.

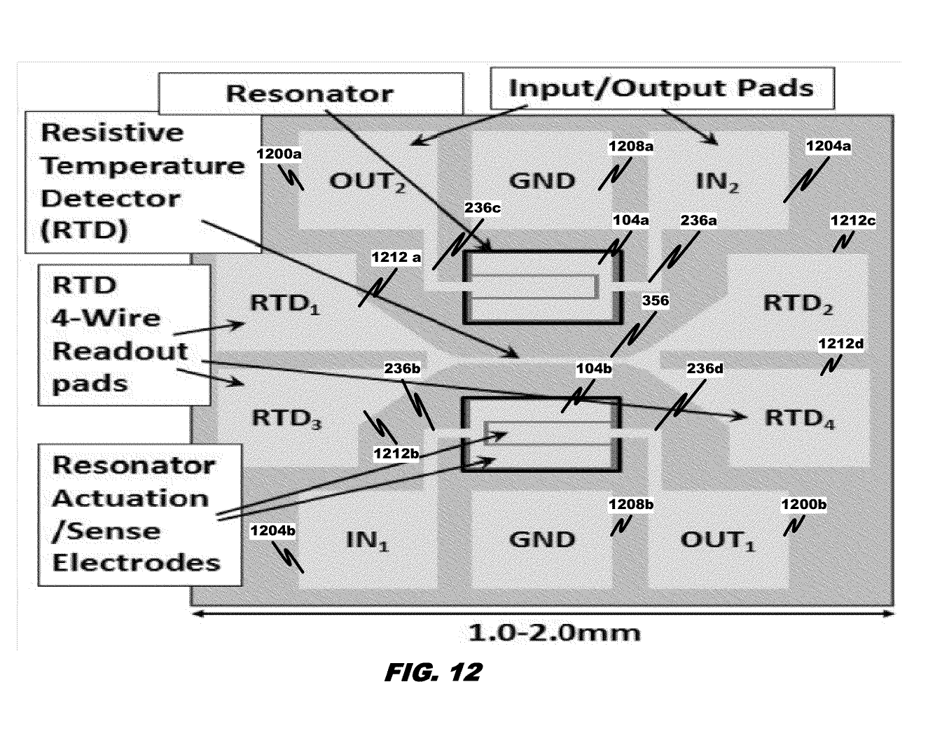

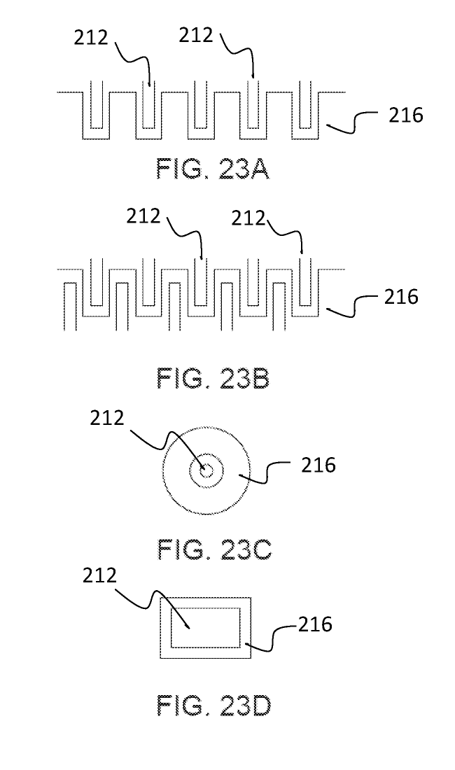

While not wanting to be limited by example, the sense electrode 216 is typically configured to resemble the letter “U” and the actuator electrode 212 can be positioned within the void of the letter “U”. Such a configuration can be used for both fundamental and the third harmonic bulk width-extensional modes of the MEMS resonator 104. Moreover, the “U” configuration can have a substantially low impedance, commonly in the order of a few hundred ohms. The low impedance makes such a configuration well suited for an oscillator circuit. The MEMS resonator chip 200 can include, in some configurations, first and second MEMS resonators 104a,b (FIG. 12). MEMS resonator chips 200 having two or more MEMS resonators 104a,b can provide for redundancy and higher reliability. The multiple MEMS resonators 104a,b can be operated simultaneously or in an alternating manner for dew point measurements. Furthermore, MEMS resonator chips 200 having two or more MEMS resonators 104a,b can allow the MEMS resonator chip 200 to keep working, even if one of the MEMS resonators 104a,b is damaged or starts to produce unreliable data. The dew point meter can alarm the user to plan for a MEMS resonator chip replacement, while it continues to operate with a single working MEMS resonator. While not wanting to be limited by example, it can be appreciated that the MEMS resonator 104 can comprise any interdigitated configurations of one or more actuator electrodes 212 and one or more sense electrodes 216, as shown in FIG. 23.

The MEMS resonator chip 200 can function as a highly sensitive balance for measuring mass. The MEMS resonator chip 200 is capable of conducting highly sensitive measurements of mass under harsh and unpredictable conditions, such as under one or both of high pressure and temperature.

The width of the gap 220 between the actuator and sense electrode(s) 212 and 216 is determined largely by the need to electrically isolate the electrodes from each other. The higher the drive voltage, the greater the spacing has to be. Additionally, the higher the contamination level, the greater the space has to be to prevent bridging of the electrodes by contaminants.

While any MEMS resonator may be employed, piezoelectric MEMS resonators are typically employed. The formation of a condensed (i.e., liquid or solid phase) phase from a gas phase is temperature-dependent process. Taking water as an example, the formation of a condensed, liquid (dew) or solid (frost), phase from gaseous phase water in air is dependent on the temperature of the air. Thermal-piezoresistive and capacitive MEMS resonators can lack durability and accuracy for detecting the formation of a condensed phase under harsh and/or unpredictable conditions. Self-heating of thermally-actuated resonators can complicate accurate temperature measurements. Furthermore, the need for a direct current bias voltage to operate the resonator can be a major issue for both thermal and capacitive resonators. In some instances, the direct current thermal and capacitive resonators can generate sufficient thermal energy to inhibit or prevent the formation of a condensed phase (i.e., dew or frost) on the resonator. Thermally actuated MEMS resonators and self-sustained oscillators generally self-heat. Therefore, the resonator temperature is elevated with respect to the surroundings, and the resonator is warmer than its surrounding surfaces on the chip. This temperature differential can cause a thick dew or frost layer to form on the surrounding areas of the MEMS resonator before forming on the resonant element itself, thereby impeding or stopping altogether the operation of the resonator and causing severe contamination issues in the long term. Furthermore, the DC bias current/voltage required for operation of such devices, in contact with liquid water (e.g., dew or molten frost during recovery cycle) can cause severe galvanic corrosion of the structure and its aluminum wires.

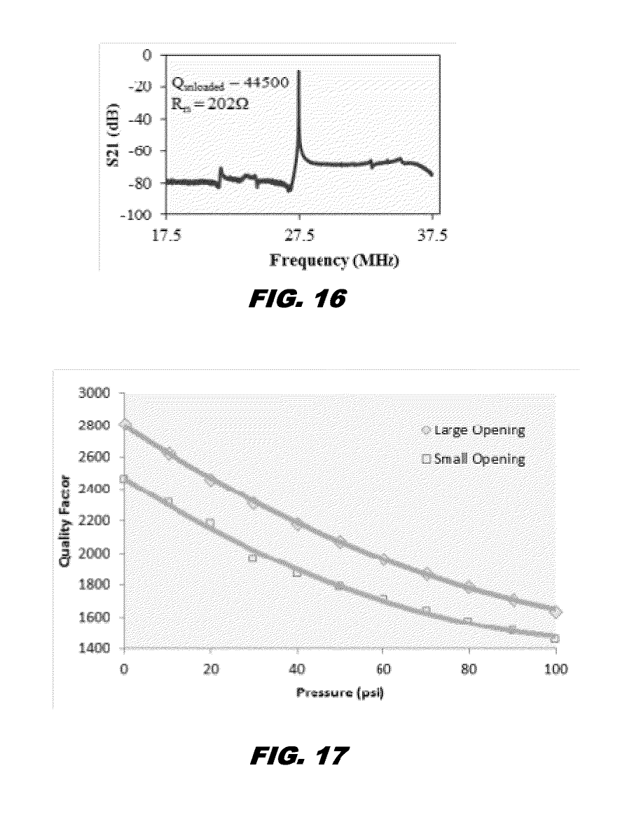

By contrast, a direct current bias voltage is commonly not needed for piezoelectric MEMS resonators. Piezoelectric resonators operate on a small alternating current voltage of a few millivolts leading to almost no noticeable self-heating. The lack of direct current bias can substantially reduce, or eliminate, corrosion. Piezoelectric MEMS resonators have little, if any, ohmic loss; that is, the piezoelectric MEMS resonators have little, if any, no self-heating. Typically, the piezoelectric MEMS resonators operate in the range of about 5 to about 50 MHz, more typically in the range of about 10 to about 40 MHz, and even more typically in the range of about 20 to about 30 MHz. Standard microprocessor circuitry can easily handle and measure these piezoelectric MEMS resonator output frequencies. Furthermore, piezoelectric MEMS resonators can have dimensions that are easy to manufacture and provide large enough area for electromechanical transduction. Moreover, piezoelectric MEMS resonators can have low impedance. Long-term accelerated tests have established not only the ability of piezoelectric MEMS resonators to produce accurate and repeatable measurements but also the durability and reliability of piezoelectric resonators with horizontal dimensions in the range of about 100 to about 200 μm and a resonant frequency of about 25 MHz. FIG. 16 shows a typical frequency response for a 27 MHz thin film piezoelectric MEMS silicon resonator with an unloaded Q of about 45,000 in air.

The MEMS resonator chip 200 can further include one or more ground contact pads 1208. The ground contact pads 1208 can be any metal. Suitable metals are without limitation a transition metal, group 8 metal, group 3a metal, group 4a metal, lanthanide metal, or alloys thereof. The metallic electrode can be one of Al, Sc, Ti, V, Cr, Mn, Fe, Co, Ni, Cu, Zn, Ga, Ge, Y, Zr, Nb, Mo, Tc, Ru, Rh, Pd, Ag, Cu, In, Sn, Sb, La, Hf, Ta, W, Re, Os, Ir, Pt, Au, Tl, Pb, Ce, Pr, Nd, Pm, Sm, Eu, Gd, Tb, Dy, Ho, Er, Tm, Yb, Lu, or a mixture or alloy thereof. In some configurations, the ground contact pads 1208 can comprise one of molybdenum, platinum, gold, or chromium.

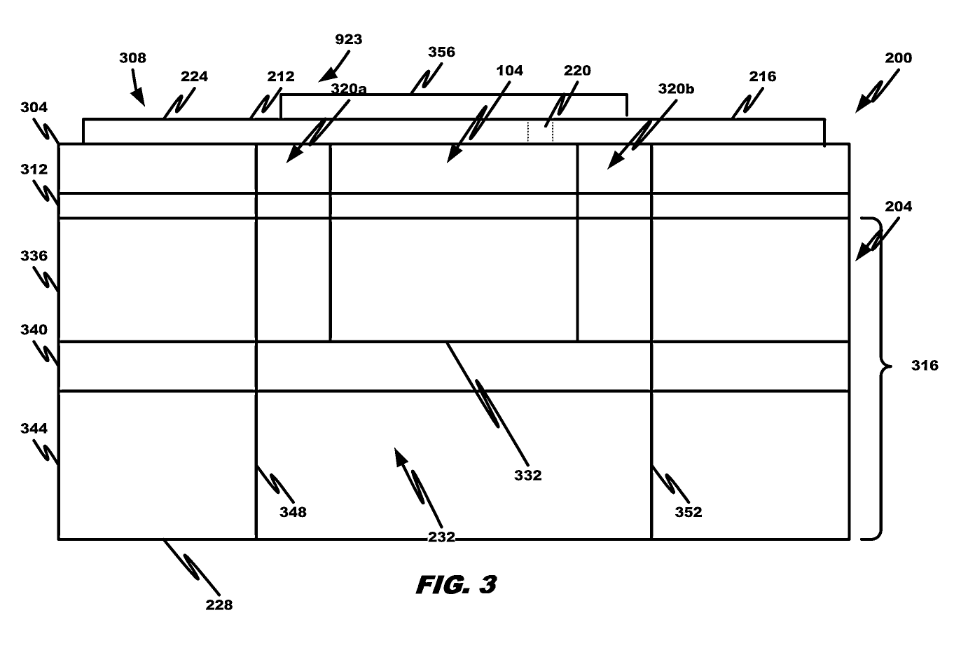

FIGS. 2 and 3, respectively, show elevation and cross-sectional views of the MEMS resonator chip 200 having opposing top and bottom MEMS resonator chip surfaces 224 and 228, respectively. The resonator chip body 204 has resonator chip void 232 substantially surrounding the edges of the MEMS resonator 104 and positioned below the bottom of the MEMS resonator 104. The MEMS resonator 104 is positioned within at least some, but not necessarily all, of resonator chip void space 232.

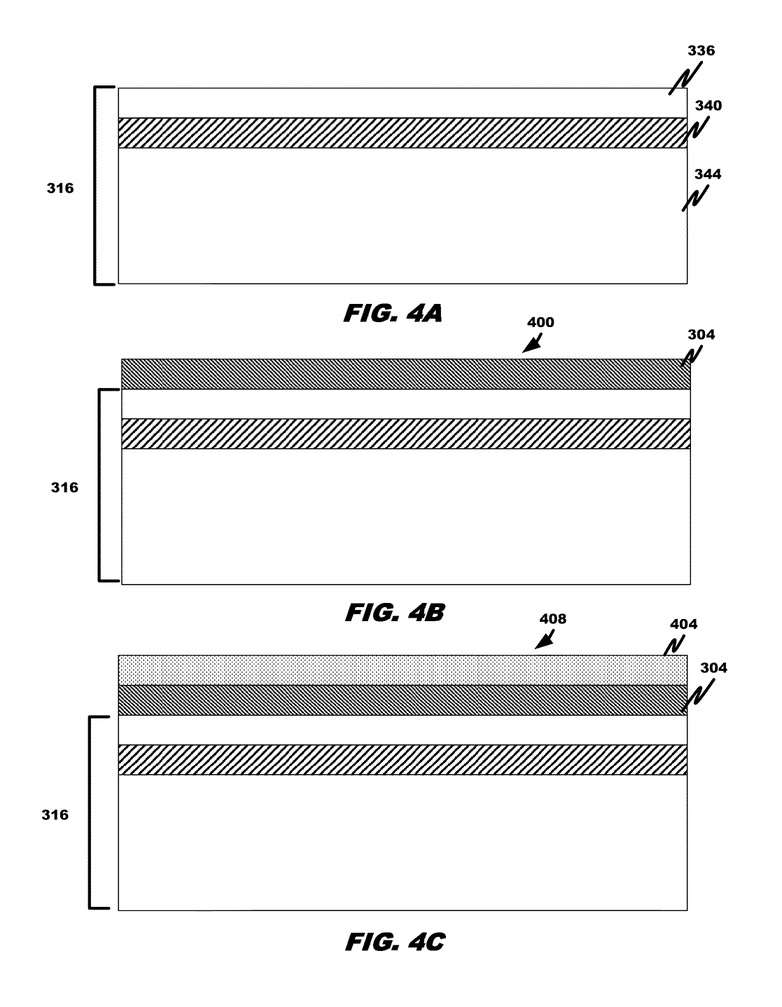

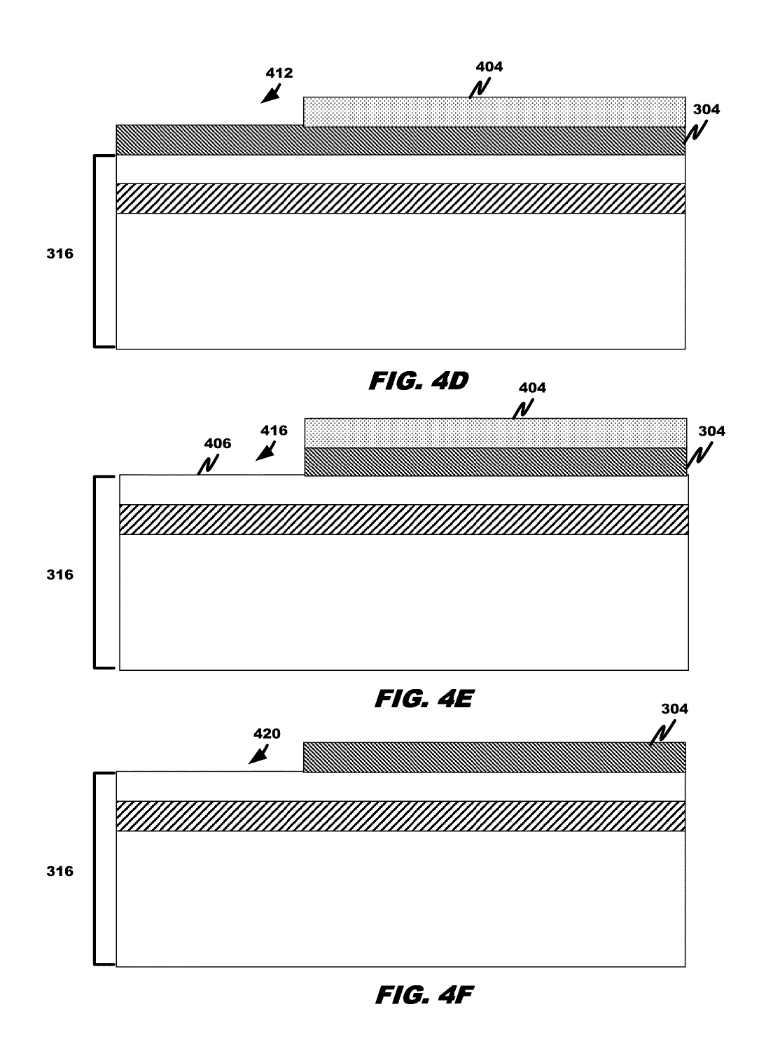

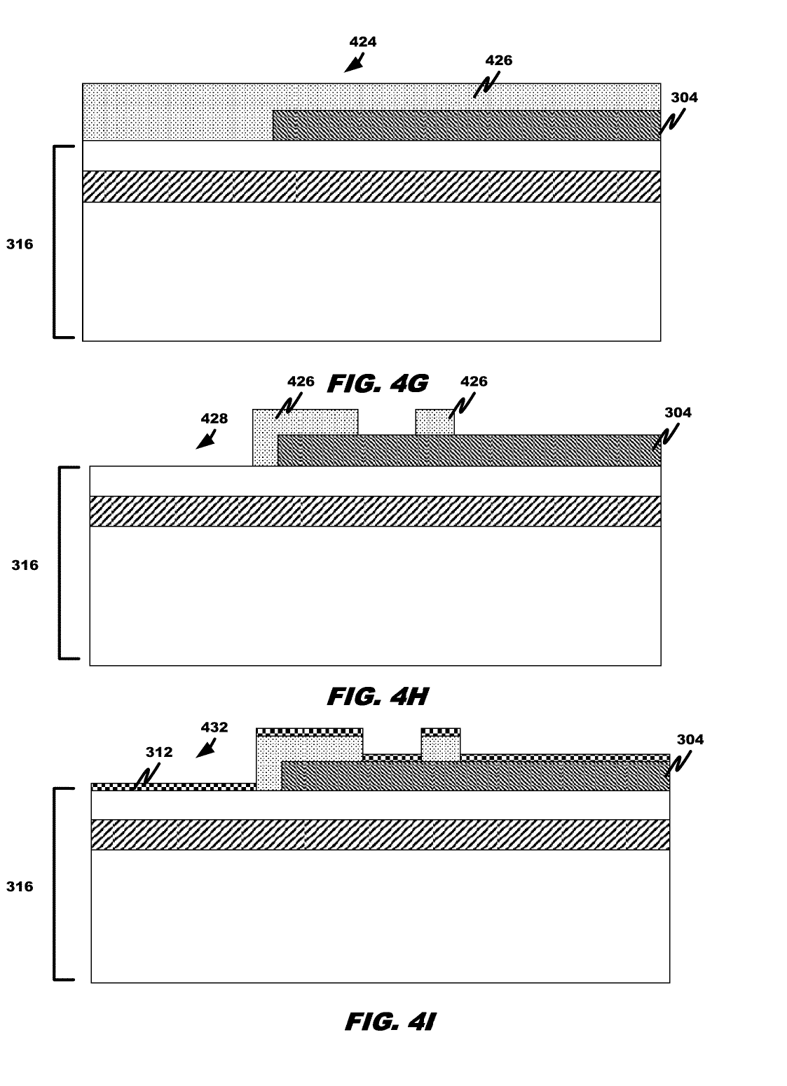

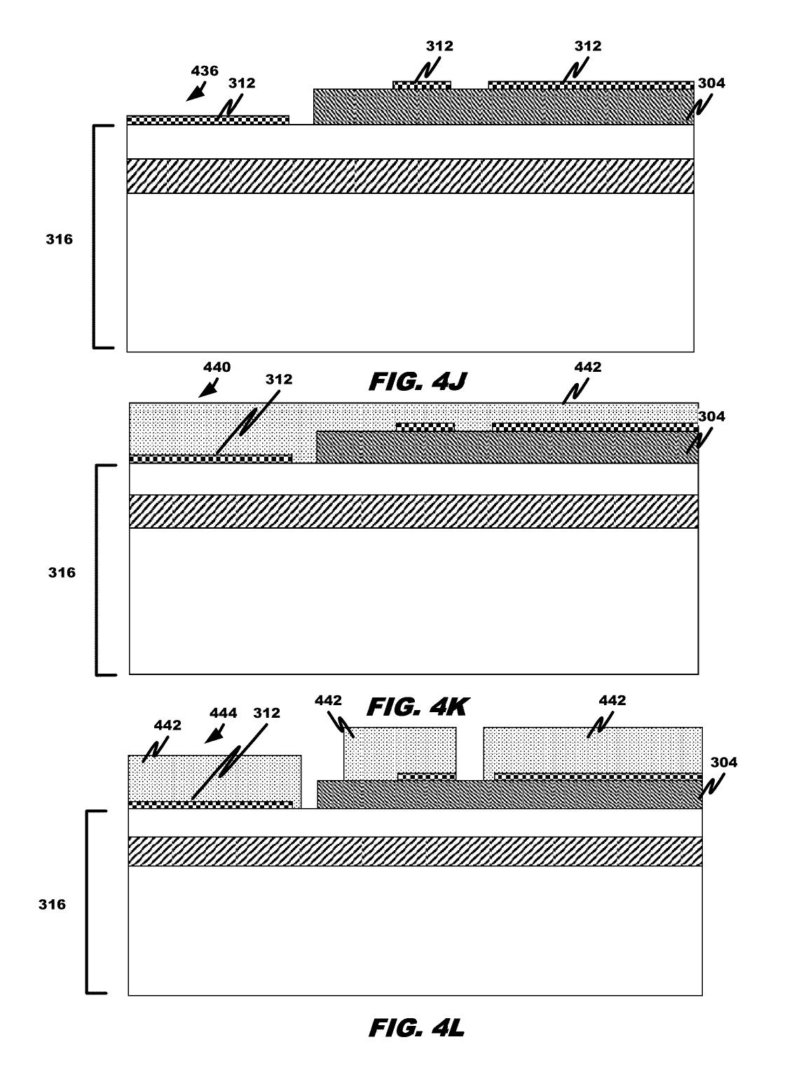

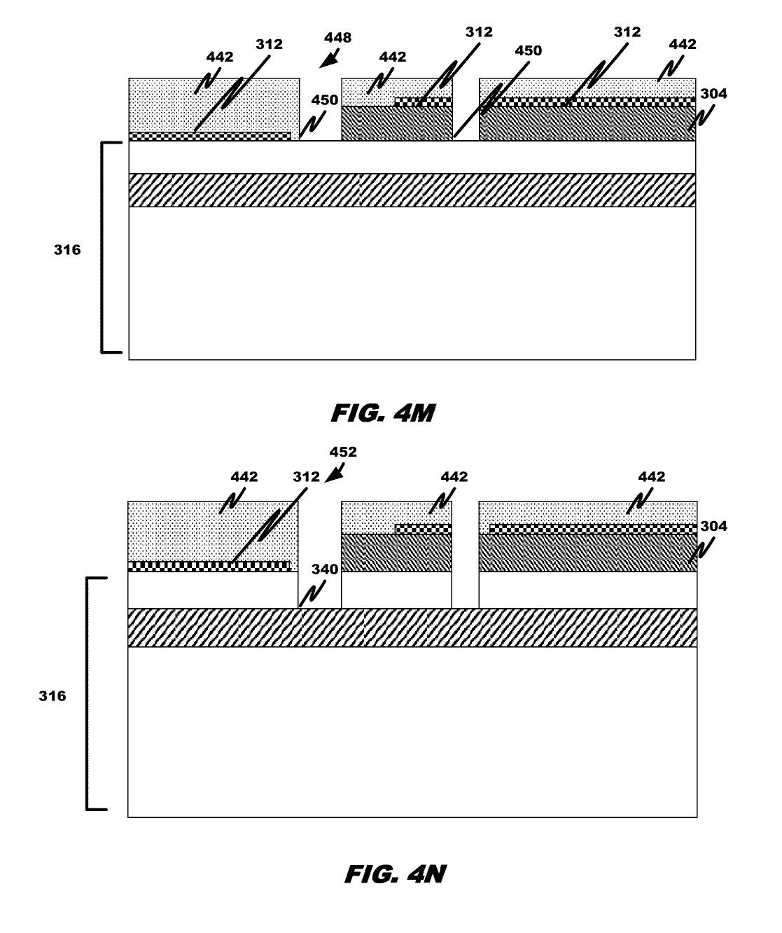

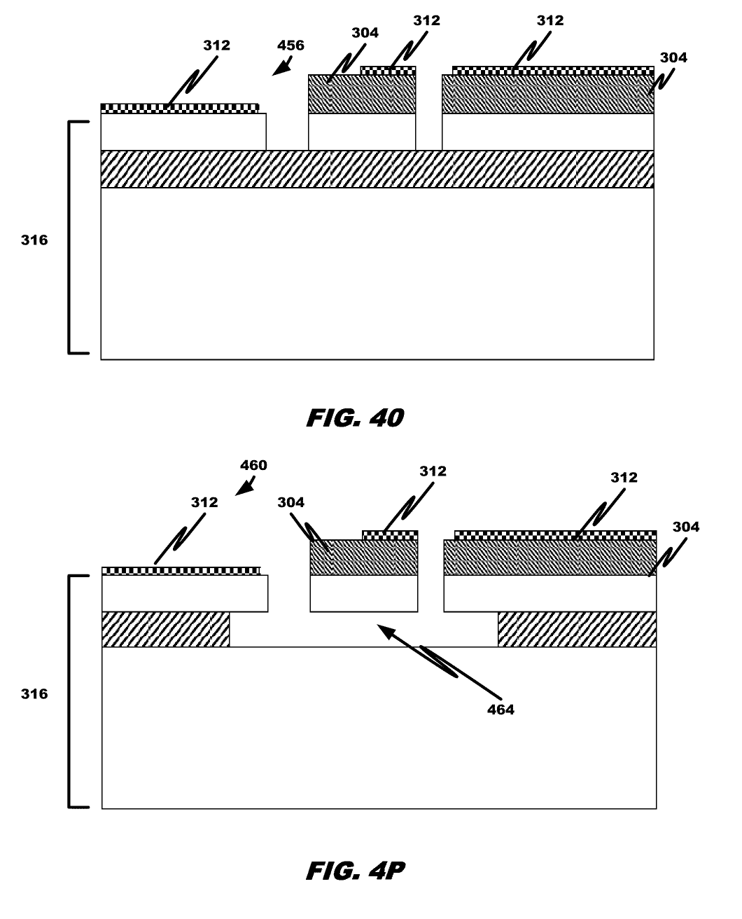

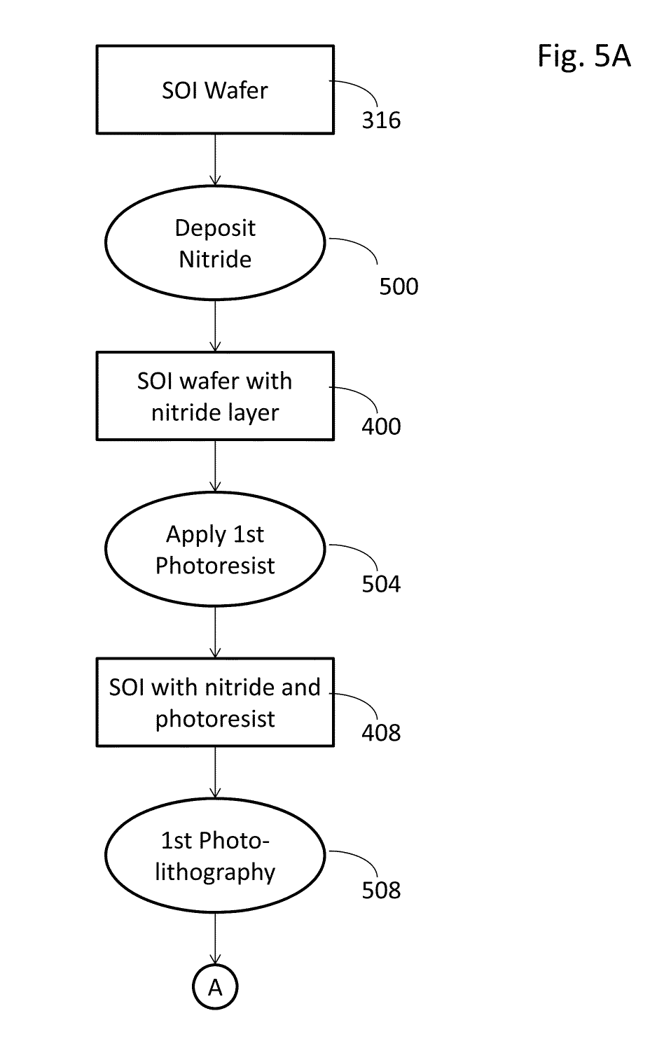

The MEMS resonator 104 comprises a thin piezoelectric aluminum nitride (AlN) film 304 sandwiched between an upper metallic electrode 308 and a lower metallic electrode 312, which define a capacitance that varies with resonant frequency. The piezoelectric film 304 may be other piezoelectric materials, such as lead zirconia titanate (PZT), zinc oxide (ZnO), and the like. Typically, the upper and lower metallic electrodes 308 and 312, respectively, comprise the same metals. However, in some configurations the metallic electrodes can comprise different metals. The MEMS resonator 104 may alternatively be comprised of a thin piezoelectric aluminum nitride (AlN) film 304 sandwiched between an upper metallic electrode 312 and a lower silicon electrode 336 as shown in FIG. 4P, which define a capacitance that varies with resonant frequency.

The MEMS resonator 104 is a bulk mode resonator that preferably operates in bulk mode oscillations as opposed to flexural or torsional mode oscillations, as is the case with a micro-cantilever beam. In a flexural mode, as in cantilevers, the resonating structure bends or deflects periodically. In a bulk mode oscillation, a bulk of material expands and contracts. Bulk mode oscillations are much less susceptible to the surrounding gas pressure and can therefore be actuated to relatively large amplitudes even under high gas pressure. Flexural modes however, are severely damped by the surrounding gas pressure and are suitable for operation under vacuum.

With reference to FIGS. 2, 3 and 12, the upper metallic electrode 308 can comprise one or more of the actuator and sense 212 and 216 electrodes, respectively, the input and output pads 1204a, b and 1200a, b, the input and output leads 236a-d, and ground pads 1208a and b. For example, in some configurations the upper metallic electrode 308 can comprise the actuator and sense electrodes 212 and 216 and be in contact with the aluminum nitride 304. That is, the actuator and sense electrodes 212 and 216 are in contact with the aluminum nitride 304. However, in some configurations, the upper metallic electrode 308 is positioned between the aluminum nitride 304 and the actuator and sense electrodes 212 and 216. That is, the actuator and sense electrodes 212 and 216 are positioned on first surface of the upper metallic electrode 308 and the aluminum nitride 304 is positioned on second surface of the upper metallic electrode 308, the first and second surfaces of the upper metallic electrode 308 being in an opposing relationship. Accordingly, it can be appreciated by a person of ordinary skill in the art that one or more of the input and output pads 1204 and 1200, the input and output leads 236, and ground pads 1208 can be in contact with the aluminum nitride 304 or in contact with the first surface of the upper metallic electrode 308. In other chip configurations, the metallic electrode is in contact with the silicon layer 336.

The actuator and sense electrodes 212 and 216 can comprise any conductive metal. Suitable conductive metals are without limitation a transition metal, group 8 metal, group 3a metal, group 4a metal, lanthanide metal, or alloys thereof. The metallic electrode can be one of Al, Sc, Ti, V, Cr, Mn, Fe, Co, Ni, Cu, Zn, Ga, Ge, Y, Zr, Nb, Mo, Tc, Ru, Rh, Pd, Ag, Cu, In, Sn, Sb, La, Hf, Ta, W, Re, Os, Ir, Pt, Au, Tl, Pb, Ce, Pr, Nd, Pm, Sm, Eu, Gd, Tb, Dy, Ho, Er, Tm, Yb, Lu, or a mixture or alloy thereof. In some configurations, the conductive metal can comprise one of molybdenum, platinum, or gold. It is believed that the use of platinum as the actuator and sense electrodes 212 and 216 can provide for one or both of lower resonant frequencies and better corrosion resistant for the MEMS resonator 104. Accordingly, it can be appreciated by a person of ordinary skill in the art that one or more of the input and output pads 1204 and 1200, the input and output leads 236, and ground pads 1208 comprise the conductive metal. Typically, the input and output pads 1204 and 1200, the input and output leads 236, and ground pads 1208 comprise the same conductive metal as the actuator and sense electrodes 212 and 216.

The resonator 104 is configured as a resonant structure suspended above the void space 232 by narrow support elements 320a,b protruding from the surrounding edges 348 and 352 of the chip and positioned on either side of the resonator 104. The mass of the resonator 104 is larger than that of the cumulative mass of the support elements 320a,b. Typically, the mass of the resonator 104 ranges from about 1,000 to about 100,000% of the cumulative mass of the support elements 320a,b and constitutes from about 10 to about 50% of the total mass of the resonator chip 200. The width of the gap 324 between the outer edges of the resonator 104 and the surrounding edges of the pocket in the chip body 204 surrounding the resonator 104 (including edges 348 and 352 of the chip) typically ranges from about 10 to about 50% of the width or length of the resonator 104.

While not wishing to be bound by any theory, it is believed that the actuator electrode 212 performs as the drive electrode to cause vibration of the resonator 104. An alternating current signal is applied to the actuator electrode 212 to generate a periodic stress wave in the resonator 104. When the frequency of the input alternating current signal reaches the mechanical natural resonant frequency of the resonator 104, a strain wave and/or vibration (or oscillation) is generated within the resonator 104 is picked up and/or perceived by the sense electrode 216. The sense electrode 216 can translate the mechanical vibrations of the resonator 104 into proportional electrical signals, typically in form of an electrical current proportional to the vibration amplitude of the resonator 104. The actuator electrode 212 and sense electrode 216 are designed to yield the minimum series impedance, such as maximum output current, for the resonant 104.

The resonator 104 is interconnected electrically to the resonator chip body 204 by the input and output leads 236a-d. The input leads 236a,b electrically interconnect the input pads 1204a,b with the sense electrode 216, and the output leads 236c,d electrically interconnect the output pads 1200a,b with the actuator electrode 212. The resonator 104 can be electrically interconnected to the resonator chip body 204 by at least the input and output leads 236 positioned on the support elements 320a,b. The support elements 320a,b typically comprise a layer of aluminum nitride 304 positioned between the input or/and output lead 236 and the lower electrode layer 312. The lower electrode layer 312, in turn, is typically positioned between the aluminum nitride layer 304 and a silicon layer 316.

The resonator chip body 204 comprises the lower metallic layer 312 positioned between, and in contact with, the aluminum nitride layer 304 and a silicon-on-insulator substrate 316. The silicon-on-insulator substrate 316 can comprise a layer of silicon dioxide 340 positioned between first and second layers of silicon 336 and 344. The bottom MEMS chip surface 228 comprises the second layer of silicon 344. The first layer of silicon 336 is positioned between lower metallic electrode 312 and the layer of silicon dioxide 340. The aluminum nitride layer 304 has opposing upper and lower aluminum nitride surfaces in contact with the upper and lower metallic electrodes 308 and 312, respectively. The ground pads 1208a,b, the input and output pads 1204 and 1200, and at least some of the input and output leads 236 are positioned on the upper surface of the aluminum nitride.

The MEMS resonator chip 200 commonly comprises materials that are highly stable and corrosion resistant. For example, platinum is one of the most corrosion resistant metals. The actuator and sense electrodes 212 and 216 typically comprise platinum. Similarly, the input and output pads 1204 and 1200, input and output leads 236, and ground pads 1208 can comprise platinum. The aluminum nitride layer 304 and silicon-containing layers 336, 340, and 344 are stable in acidic environments but can under some conditions be prone to corrosion in basic environments. When corrosion is an issue, the MEMS resonator chip 200 can be coated in an insulating protective layer (not shown) so that the electrical behavior of the chip 200 does not change due to accumulation of contaminants or mechanical damage. The simplest and most effective coatings to be deposited on the MEMS resonator chip 200 without interfering with the operation of different components are silicon dioxide and silicon nitride. Both are glass-like inert materials that can be deposited at a low temperature that does not damage the metal-containing components (such as, but not limited to, the upper and lower metal electrodes 308 and 312, actuator electrode 212, sensor electrode 216, the resistive temperature detector (discussed below), ground pads 1208, temperature readout pads (discussed below), the input and output pads 1204 and 1200 and the input and output leads 236), aluminum nitride layer 304, or both. Other more sophisticated approaches including stacks of inert metals, highly resistant polymers (e.g., parylene), and silicon oxide/nitride could also be used as a protective coating.

### Temperature Sensor 108

As indicated earlier, the formation of the condensed phase is temperature-dependent. Therefore, the temperature of MEMS resonator chip 200 is closely and accurately monitored to determine the temperature at which the condensed phase (e.g., dew or frost) starts to form. The temperature sensor precisely measures the temperature and factors out any temperature difference between the MEMS resonator and its surroundings. While any temperature sensor can be employed, the temperature sensor commonly includes a resistive temperature detector (RTD) 356 electrically coupled to temperature readout leads. The temperature readout leads are in turn electrically coupled to temperature readout pads 1212a-d. Although the resistive temperature detector 356 is shown being connected to four temperature readout pads, any number of readout pads may be employed.

In a four-wire measurement, a very small DC current is applied through two electrodes, where the resulting voltage drop across the resistive element is measured using two other electrodes. The measuring electrodes carry close to zero electrical current and therefore detect no voltage drop due to the contact resistance.

The resistive temperature detector 356 monitors the MEMS resonator chip 200 temperature accurately and effectively during operation and commonly includes a thin film metal resistor. Any metal having relatively large and linear temperature coefficient of resistivity can be used. Platinum is a metal having a relatively large and linear temperature coefficient of resistivity. Accordingly, the thin film metal resistor is commonly a platinum resistor. When corrosion is an issue, the resistive temperature detector and readout pads can be coated with an insulating protective layer such that its electrical resistance does not change due to accumulation of contaminants or mechanical damage.

The resistive temperature detector 356 can be positioned next to the one or more resonators 104 as depicted in FIG. 12. In some configurations, the resistive temperature detector 356 can be integrated on top of some, or all, of the one or more resonators 104.

### Method of Fabricating the MEMS Resonator Chip 200

The method of forming an exemplary MEMS resonator chip 200 is illustrated in FIGS. 4A-P and 5A-G. Schematic drawings of the MEMS resonator chip 200 in each process step are illustrated in FIGS. 4A-P. Referring to FIGS. 3 and 4A, the silicon-on-insulator (SOI) wafers 316 are comprised of a silicon base layer 344 with a buried silicon oxide layer 340, and finally, having a silicon layer 336 on the surface. The width or thickness of the SOI is not restricted.

The resonator chip fabrication method described here may or may not provide for a metal layer 312 below the nitride layer as shown in FIG. 2 and FIG. 3. The resonator chip 200 described here utilizes the silicon layer 336 to serve the function of an electrode in electrical contact with AlN. In other words, the silicon layer 336 alone can function as an electrode or the silicon layer 336 in combination with the metal layer 312 can function as an electrode. When a metal layer 312 is included, it would be deposited before the deposition of the nitride layer (i.e. before step 500).

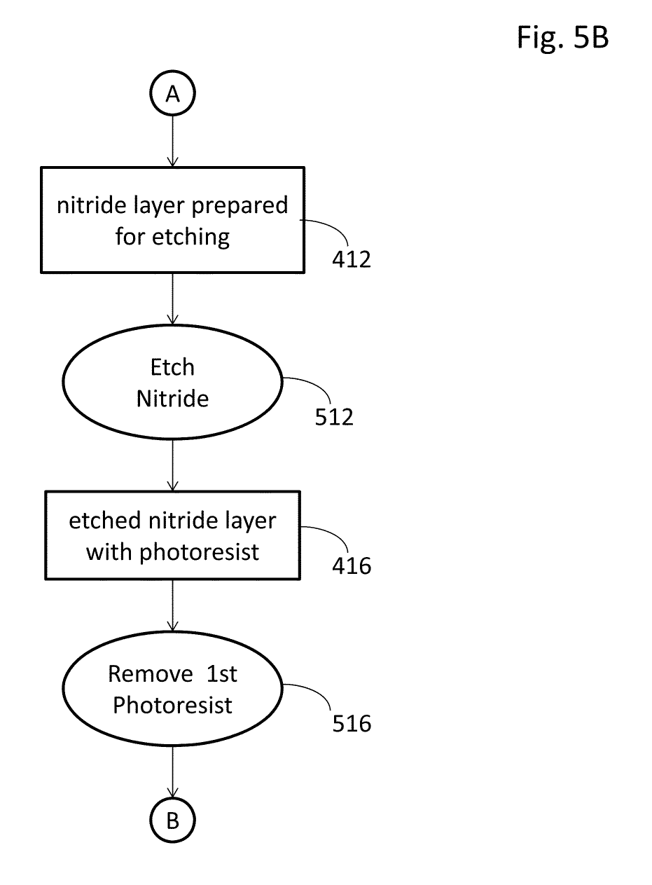

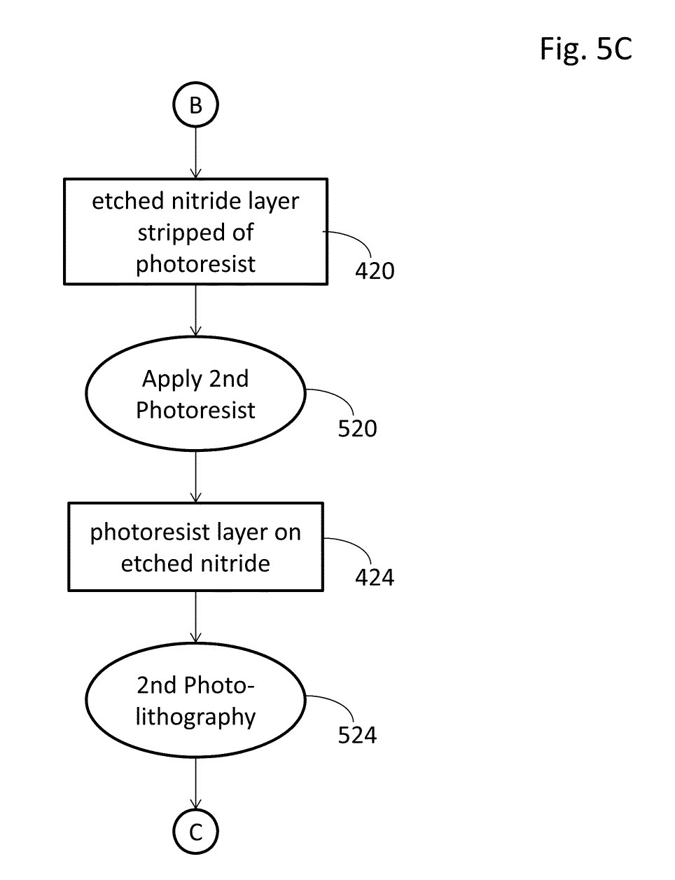

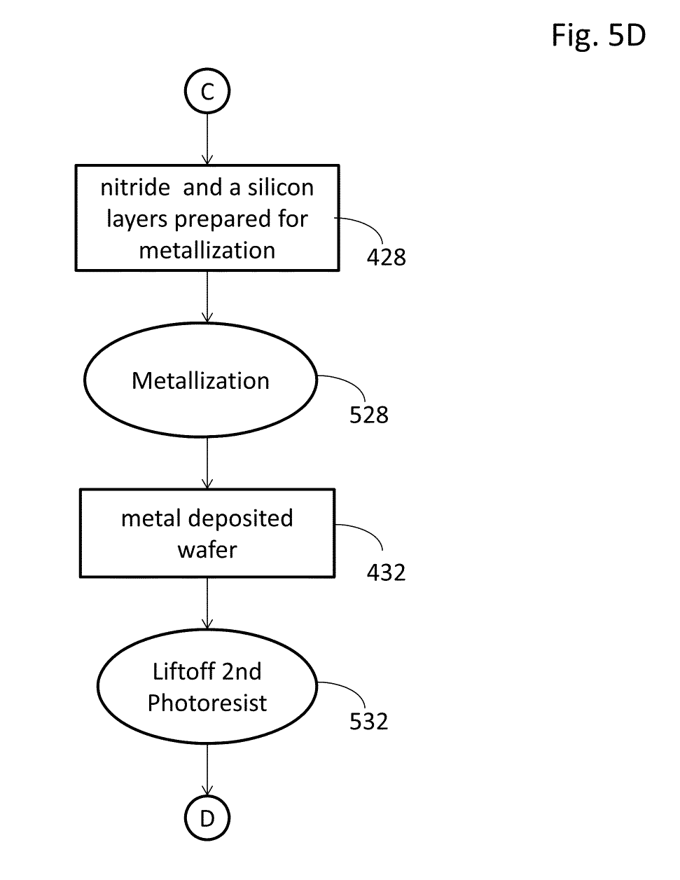

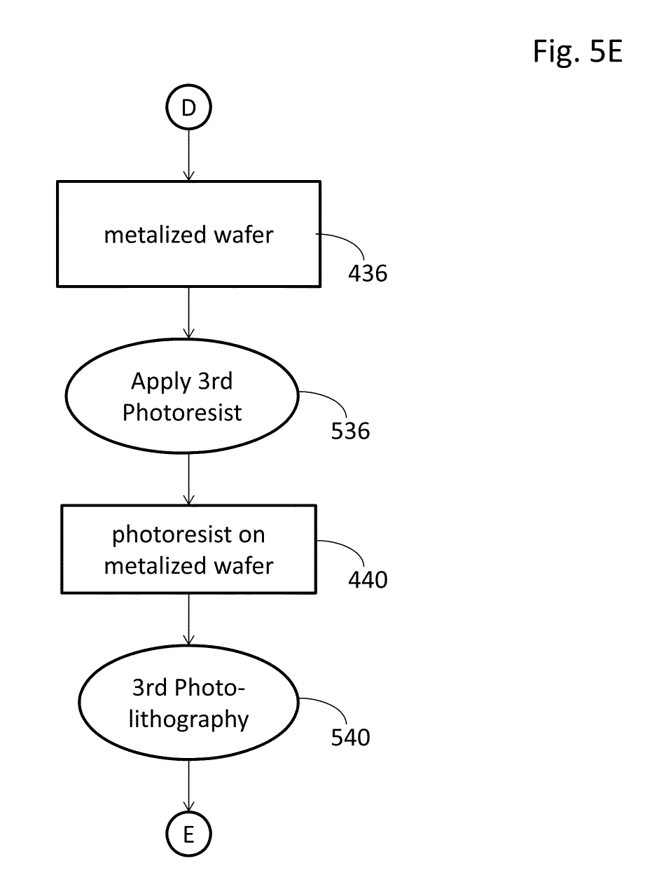

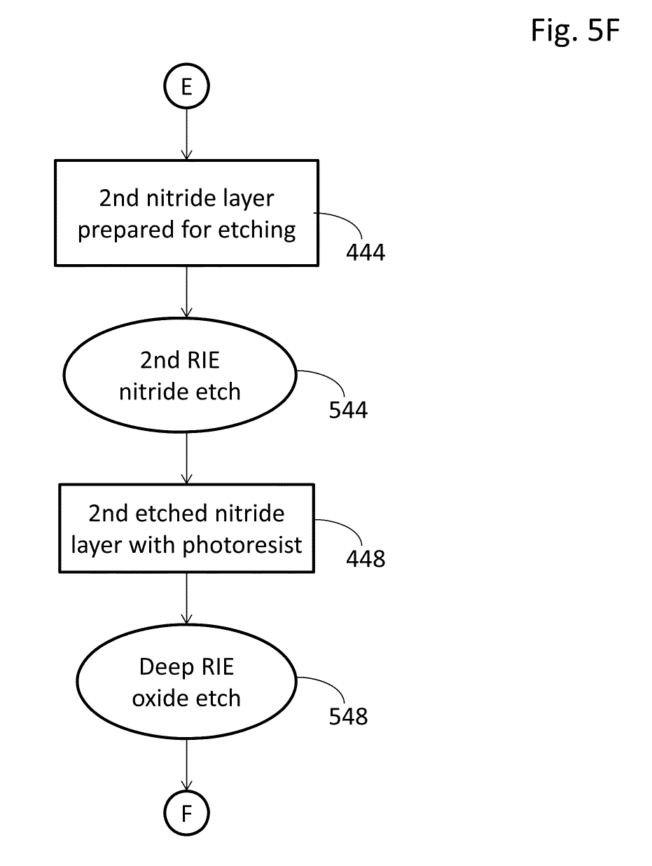

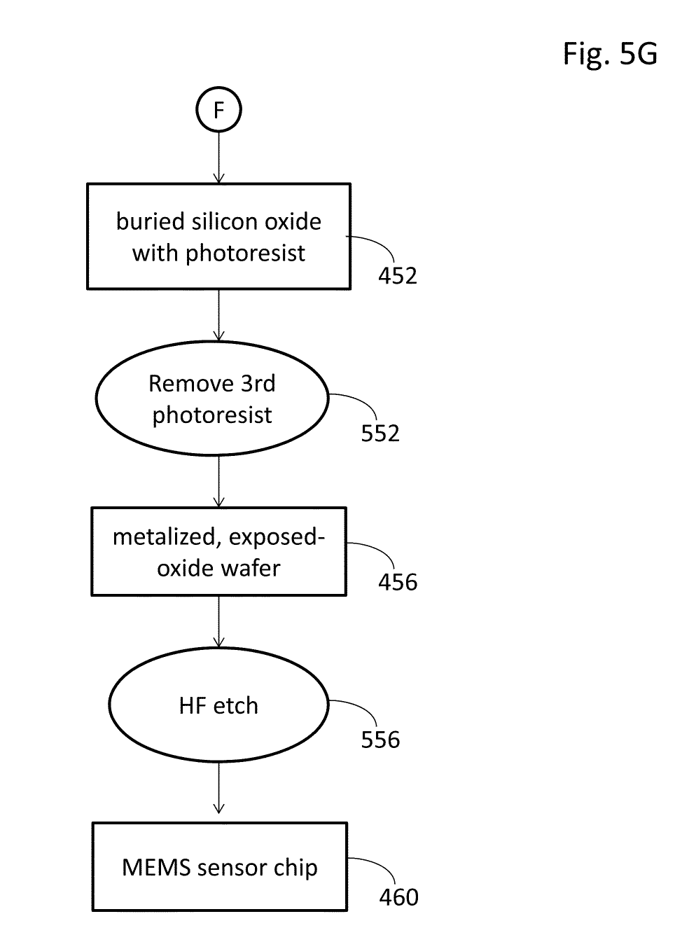

Referring to FIGS. 4B and 5A, in step 500, an approximately 300 nm thick layer film of a low stress nitride material (such as silicon nitride or aluminum nitride) is deposited on the silicon layer 336. This illustrated in FIG. 4B, as the nitride layer 304 is deposited on the silicon layer 336 to make an SOI wafer with a deposited layer of nitride 400. This deposition may be by any appropriate method, with low pressure chemical vapor deposition (LPCVD) being one such deposition method. This nitride layer 304 provides electrical insulation between the thin film metallic resistor and underlying silicon substrate. The nitride layer typically has a thickness ranging from about 0.2 to about 10 microns, and more typically from about 1-2 microns.

In step 504, a thin photoresist layer 404 is applied to the SOI wafer on top of the layer of nitride 304 (FIG. 4C) to provide an SOI with nitride and photoresist wafer 408. The application of photoresist is performed using standard photolithography methods.

In step 508, a standard photolithography process is used to generate the desired microscale patterns in the photoresist layer 404, thus making a nitride layer prepared for etching 412 as shown in FIG. 4D. The pattern is exposed through a first photolithography mask and subsequently cured. The undesired photoresist material is removed using standard photolithography methods to leave behind the desired photoresist pattern. This pattern exposes the portions of the nitride layer that will be removed in the next step.

In step 512, the exposed nitride layer 304 is etched to remove the portion of exposed nitride layer, thus making an etched nitride layer with photoresist 416, as illustrated in FIG. 4E. The etch process may be, for example, a wet etch or a dry plasma etch, as is well known in the art. Reactive Ion Etching (RIE) has been shown to be effective in this process. Referring to FIG. 4E, the etching of the nitride layer provides an exposed silicon surface 406. When a metal layer 312 is present, this etch step 512 would etch down to metal layer 312.

In step 516, the remaining photoresist 404 is removed in an oxygen plasma using standard photolithography methods, thus making an etched nitride layer stripped of photoresist 420 as illustrated in FIG. 4F. The method to use oxygen plasma to remove photoresist is well known in the art of photolithography.

In step 520, the nitride layer stripped of photoresist 420 is coated with a photoresist layer, thus forming a photoresist layer 426 on etched nitride 424, as illustrated in FIG. 4G. The photoresist layer 426 in this step, step 520, may be thicker than the photoresist layer 404 in FIG. 4C, and is applied using standard photolithography methods.

In step 524, a standard photolithography process is used to generate the desired microscale patterns in the photoresist layer 426 (from FIG. 4G), thus making a nitride layer and a silicon layer prepared for metallization 428, as illustrated in FIG. 4H. The pattern is exposed through a second photolithography mask and subsequently cured. The undesired photoresist material is removed using standard photolithography methods to leave behind the desired photoresist pattern. This pattern exposes the portions of the nitride layer 304 and silicon layer 336 that will be deposited upon with a layer of metal in the next step. When a metal layer 312 is present, it is the metal layer 312 that would be exposed and then receive an additional metal layer.

In step 528, a metal layer 312 is deposited on the exposed nitride layer 304 (in FIG. 4H) and silicon 336 (in FIG. 4H) layers, as well as the photoresist 426 (in FIG. 4H), thus making a metal deposited wafer 432, as shown in FIG. 4I. When a metal layer 312 is present, it is the metal layer 312 that would be exposed in place of the silicon, and the metal layer would receive an additional metal layer. In one configuration, a metal layer 312 is deposited via standard deposition methods, which may include e-beam deposition, RF or DC sputtering, pulsed laser deposition, or any other method of metal deposition. The metal layer may be between 10 nm and 1000 nm, but is preferably between 15 nm and 500 nm, or more preferably between 20 nm and 200 nm.

In another configuration, the metal layer 312 may comprise a plurality of layers, including an adhesion metal layer of one metal, followed by the deposition of a second, or more metal layers.

In still another configuration, an approximately 20 nm thick layer of an adhesion metal is deposited via e-beam deposition on the nitride layer 304 and silicon layer 336 to act as an adhesion promotion layer between nitride layer 304 and silicon layer 336 and the thicker metals to be deposited subsequent to the adhesion layers. The deposition of the adhesion layer is followed by the e-beam deposition of an approximately 150 nm metal layer of a second metal. The adhesion layer metals can include metals such as chromium (Cr) and molybdenum (Mo), whereas the thicker metal layer can include metals such as gold (Au) or platinum (Pt).

Referring to FIG. 3, the metallic layer 312 serves a plurality of uses depending on its location on the MEMS resonator chip 200. The metallic layer 312 may be comprised of one or layers and include one or more metals. Furthermore, the metal layer 312 may be one or more metallic pads, electrodes and/or actuators. Some of the specific electrodes and actuators that may be made from the metallic layer include: the actuation and sense electrodes, a resonator output pad, a resonator input pad, the resistive temperature detector, and/or one or more temperature readout pads.

The metallic layer(s) can be any conductive or superconductive material. Suitable metals include, without limitation, a transition metal, group 8 metal, group 3a metal, group 4a metal, lanthanide metal, or alloys thereof. The metallic layer(s) can be one of Al, Sc, Ti, V, Cr, Mn, Fe, Co, Ni, Cu, Zn, Ga, Ge, Y, Zr, Nb, Mo, Tc, Ru, Rh, Pd, Ag, Cu, In, Sn, Sb, La, Hf, Ta, W, Re, Os, Ir, Pt, Au, Tl, Pb, Ce, Pr, Nd, Pm, Sm, Eu, Gd, Tb, Dy, Ho, Er, Tm, Yb, Lu, or a mixture or alloy thereof. In some configurations, the conductive metal can comprise one of molybdenum, platinum, or gold. It is believed that the use of platinum as the actuator and sense electrodes 212 and 216 can provide for one or both of lower resonant frequencies and better corrosion resistant for the MEMS resonator 104. Accordingly, it can be appreciated by a person of ordinary skill in the art that one or more of the input and output pads 1204 and 1200, the input and output leads 236, and ground pads 1208 comprise the conductive metal. Typically, the input and output pads 1204 and 1200, the input and output leads 236, and ground pads 1208 comprise the same conductive metal as the actuator and sense electrodes 212 and 216

In step 532, the metal layer 312 anchored on top of the photoresist 426 (FIG. 4I) is removed by lifting off the photoresist 426, thus making a metalized wafer 436, as shown in FIG. 4J. The lift-off process involves immersing the wafers in hot photoresist stripper while applying ultrasonic agitation, as is known by those skilled in the art.

In step 536, the metalized wafer 436 (FIG. 4J) is coated with a photoresist layer 442, thus forming a photoresist on metalized wafer 440, as illustrated in FIG. 4K. The photoresist layer 442 in this step, step 536, may be thicker than either of the photoresist layer 404 in FIG. 4C, or 426 in FIG. 4G, and is applied using standard photolithography methods, as is known by those skilled in the art.

In step 540, a standard photolithography process is used to generate the desired microscale patterns in the photoresist layer 442 (from FIG. 4K), thus making a second nitride layer 426 prepared for etching 444, as illustrated in FIG. 4L. The pattern is exposed through a third photolithography mask and subsequently cured. The undesired photoresist material is removed using standard photolithography methods to leave behind the desired photoresist pattern. This pattern exposes the portions of the nitride layer 442 that will be etched in the next step. The exposed portions of the photoresist define the support elements and resonant structure.

In step 544, the exposed nitride layer 312 (from FIG. 4L) is etched by RIE, as is well known in the art, to remove the exposed nitride layer 312 and expose the silicon layer 336, thus making a second etched nitride layer with photoresist 448, as illustrated in FIG. 4M. Referring to FIG. 4M, the etching of the nitride layer 312 provides an exposed silicon surface 450.

In step 548, the silicon layer 336 (in FIG. 4M) is etched by Deep Reactive Ion Etching (DRIE), as is well known in the art, all the way down to the buried oxide layer 340 of the SOI wafer to form an exposed buried silicon oxide with photoresist 452, as shown in FIG. 4N.

In step 552, the remaining photoresist 442 (in FIG. 4N) is removed via an oxygen plasma to form a metalized, exposed-oxide wafer 456, as shown in FIG. 4O. The method to use oxygen plasma to remove photoresist is well known in the art of photolithography.

In step 556, the resonating structures are released from the underlying substrate by removing the underlying SOI buried oxide layer 340 (FIG. 4O) positioned beneath the resonant structure 104 and the support elements 320a,b with a hydrofluoric (HF) acid etch, to form the MEMS resonator chip 460, as shown in FIG. 4P. The HF etch leaves behind suspended silicon structures 464 in FIG. 4P with patterned thin film metal electrodes 312 insulated from the silicon 336 with the nitride layer 304 in between.

As will be appreciated, micromachining may be employed in lieu of and/or in addition to any of the above steps, and the ordering or sequence of the steps can be reversed depending on the application. For example, the resonant structure can be batch-fabricated on a semiconductor substrate using micro-machining techniques. A suspended piezoelectric material or a dielectric material can be sandwiched between conductive layers. Alternatively a stack of piezoelectric or dielectric material sandwiched between two conductive layers can be deposited on a suspended or solid region of the substrate.

### Temperature Control Device 112

The temperature control device 112 can be any suitable cooling and optionally heating device. In one configuration, the temperature control device 112 is a cooler/heater, which generally refers to a single thermoelectric device, also known as a Peltier cooler, or to a collection of thermoelectric devices that may either cool or heat what it is attached to. The temperature control device 112 may be a collection or assemblage of more than thermoelectric devices in a stack. As will be appreciated, a “Peltier cooler” generally refers to thermoelectric coolers which operate by the Peltier effect (which also goes by the more general name thermoelectric effect). Two semi-conductors, one n-type and one p-type, are used to provide different electron densities. The semi-conductors are placed thermally in parallel to each other and electrically in series and then joined with a thermally conducting plate on each side. When a voltage is applied to the free ends of the two semiconductors, there is a flow of DC current across the junction of the semi-conductors causing a temperature difference. The side with the cooling plate absorbs heat which is then moved to the other side end of the device (or “hot side”) where a heat sink is located. The “hot” side is attached to a heat sink so that it remains at ambient temperature, while the cool side goes below room temperature. Thermoelectric coolers are typically connected side-by-side and sandwiched between two ceramic plates. The cooling ability of the total unit is then proportional to the number of thermoelectric coolers in it. In some applications, multiple coolers can be cascaded together for lower temperature. They can be used either for heating or for cooling (refrigeration), though in practice the main application is cooling.

### The Dew Point Meter Housing

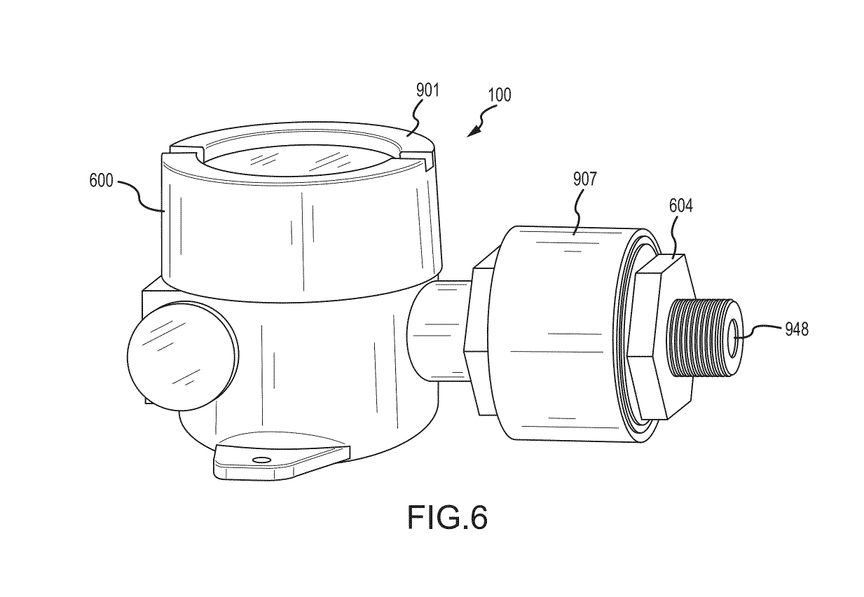

FIGS. 6-9 and 15 show different components of the dew point meter 100. FIG. 6 shows a three-dimensional plan view of dew point meter 100. The dew point meter 100 includes a housing assembly 901. The housing assembly 901 generally has two compartments, a first compartment 902 for housing the MEMS resonator chip 200 and other components and a second compartment 903 contained in a main housing body 600 for containing the circuitry and display of the dew point control module 116. The housing assembly 901 can be suitable for be use in hazardous areas with the potential for explosive gases accumulating. The main housing body 600 containing the second compartment 903 can be, for example, a Limatherm™ XD-Iwin™ explosion proof housing. It is believed that this type of housing will meet CSA and FM certification for safe use in Class I Group B, C and D, Division I and II hazardous areas in North America and ATEX Zones 0, 1, 2 certification for use outside of North America. Furthermore, the Limatherm™ XD-Iwin™ explosion proof housing can be equipped with glass windows on the top side 904 for placing a display. More typically, the housing assembly 901 is an explosion-proof metallic housing. Moreover, the dew point meter 100 can generally tolerate pressures of 1,000 psi or less, more generally of 750 psi or less, even more generally of 500 psi or less, or even more generally of 250 psi or less.

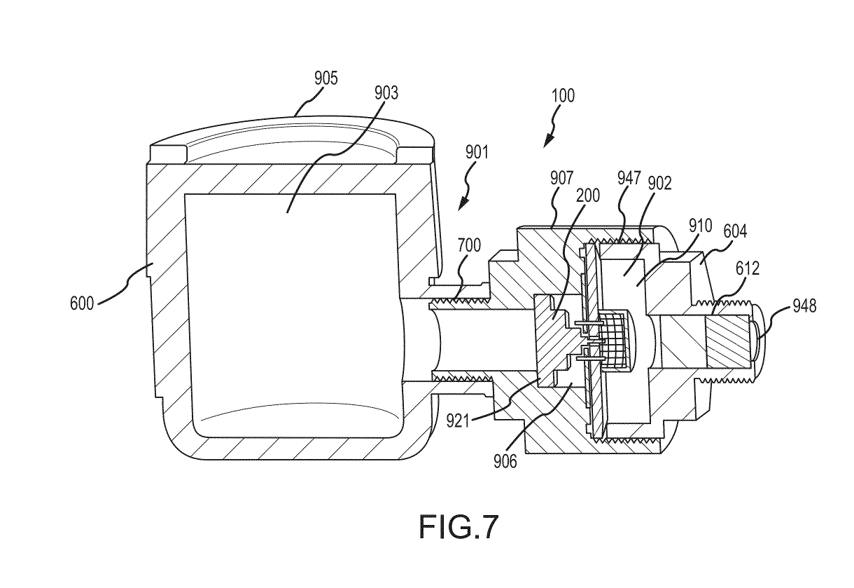

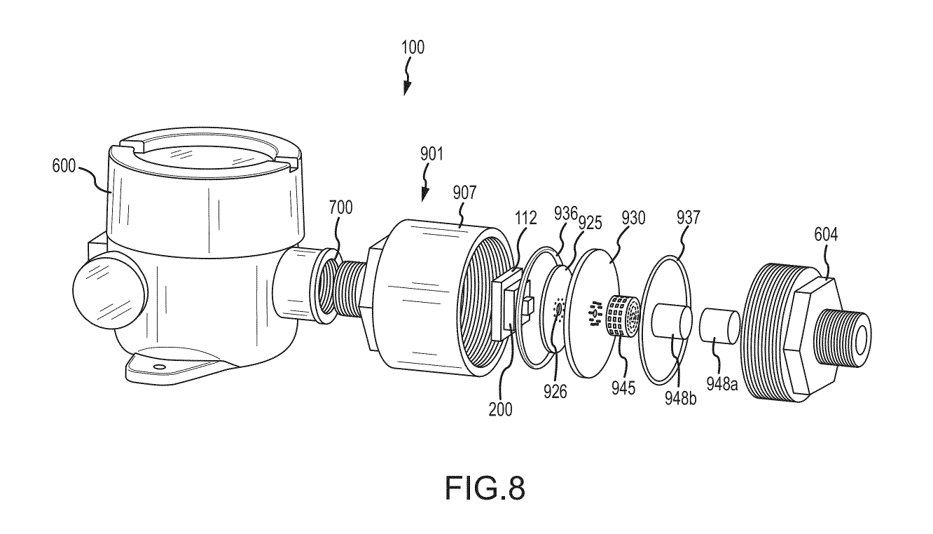

FIGS. 7-8 are, respectively, cross-sectional and exploded views of FIG. 6 (the circuitry and display of the dew point control module 116 are not depicted). As shown in the exploded view, the first compartment 902 comprises a sensor sub-compartment 906 and dew point control sub-compartment 910 and is enclosed by a sensor compartment body 907 and a sensor compartment end cap 604, which are positioned in an inlet 700 of the main housing body 600. The sensor sub-compartment 906 is in fluid communication with the remainder of the first compartment 902 and the second compartment 903. The sensor compartment body 907 is received in the inlet 700, the sensor compartment end cap 604 is received in the opposing inlet 947 of the sensor compartment body 907, and a gas permeable and porous plug 948 is received in an inlet 612 of the sensor compartment end cap 604. These components can be permanently or removably joined together by threading (as shown), an adhesive, or both.

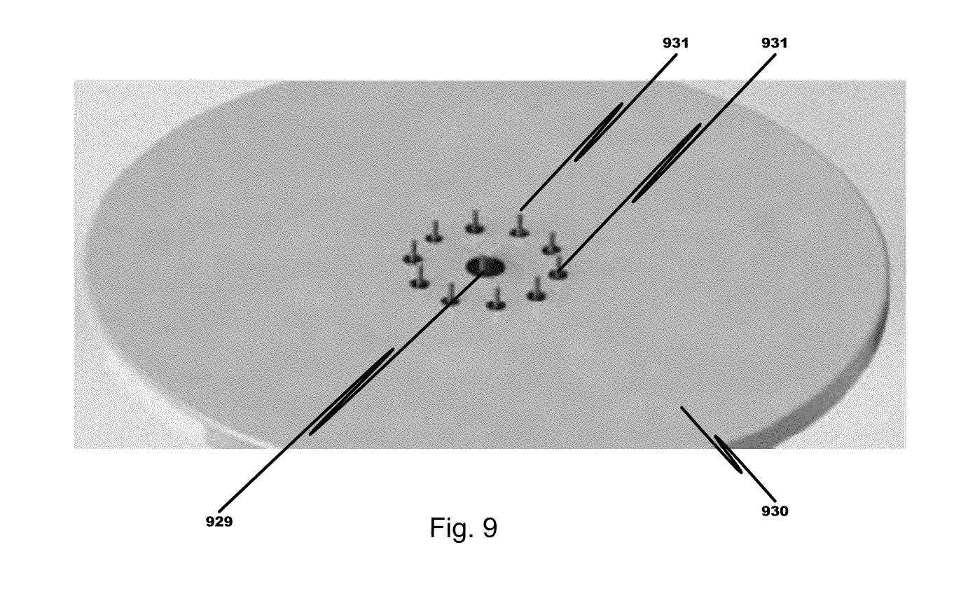

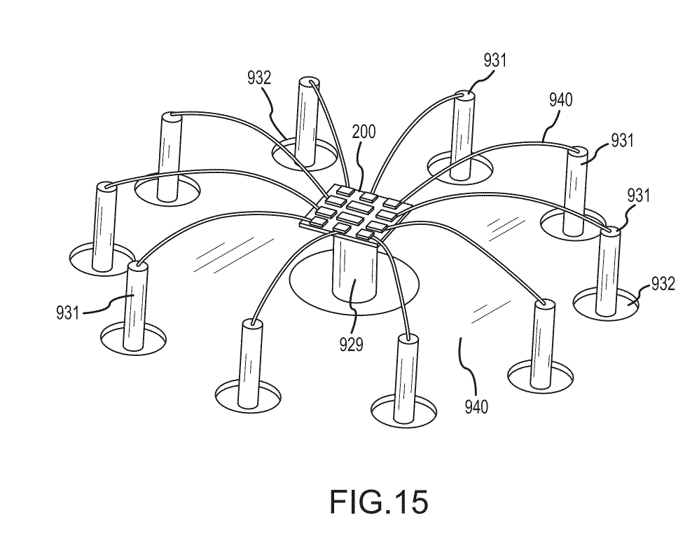

The exploded view of FIG. 8 shows the various components of the dew point meter 100. The temperature control device 112 is engaged with the MEMS resonator chip 200 to form the sensor head and the sensor head positioned in the sensor sub-compartment 906. The backside 921 (that is, the hot side) of the temperature control device 112 can be in thermal contact with the thermally conductive housing assembly 901 to dissipate heat. In other words, the metallic housing assembly 901 can act as a heat sink for the temperature control device 112. A printed circuit board 925, containing the sustaining amplifier 1004, the controller 1000, and computer readable medium 1280, has a central aperture 926 about the size of the metallic post 929 that is in thermal contact with the MEMS resonator chip 200. The top surface 923 is received in the central aperture 926 to enable the printed circuit board 925 to be mounted on top of the temperature control device 112. The central aperture 926 allows the temperature control device 112 top surface to come into thermal contact with the metallic post 929 (FIGS. 9 and 15).

The printed circuit board 925 is typically placed as close to the MEMS resonator chip 200 as possible. For example, the MEMS resonator chip 200 is mounted on chip platform 930 and the printed circuit board 925 can be placed immediately adjacent to chip platform 930 to minimize the length of wires carrying high frequency signals from the resonator to the amplification circuitry. The low signal level and high frequency of the MEMS resonator 104 output signal makes it susceptible to electromagnetic interference from outside sources. Electromagnetic interference can be conducted from electrical noise sources on any communication or power wires connecting the outside world to the instrument. Electromagnetic interference can also be radiated from electrical equipment or natural sources to the device. Therefore, the printed circuit board 925 is placed as close to the resonator 104. Furthermore, the chip platform 930 is fabricated to withstand high pressures and substantially block at least most, if not substantially all, the pressure on MEMS resonator chip 200 from being delivered to the printed circuit board 925, while allowing electrical signals to be delivered to and from the MEMS resonator chip 2000 to the printed circuit board 925. The chip platform 930 can generally tolerate pressures of 100 psi or more, more generally of 250 psi or more, even more generally of 500 psi or more, even more generally of 750 psi or more, or still even more generally of 1,000 psi or more. Typically, the chip platform 930 can withstand and/or block pressures of 1,000 psi or less, more typically withstand and/or block pressures of 750 psi or less, even more typically of 500 psi or less, or yet even more typically of 100 psi or less. The chip platform 930 can be machined out of stainless steel.

Electrical connections are provided to the MEMS resonator 104 through a sealed metallic plate using conductive feed-throughs sealed by an insulating material, e.g. glass. The metallic plate, or chip platform 930, can have a plurality of conductive feed-throughs in the form of metal pins 931, with each metal pin 931 passing through glass-to-metal seals 932. The metal pins 931 are connected to the resonator chip 200 input and output metallic pads 1204 and 1200 using bonded micro-wires or suspended metallic cantilevers. The glass-to-metal seals 932 electrically isolate the metal pins 931 from the chip platform 930. The glass-to-metal seals 932 can withstand the high-pressure on the MEMS resonator chip 200 side of the chip platform 930. The sealed metallic plate blocks leakage of the gas under test to the other side of the chip platform. Furthermore, by blocking the leakage to the other side of the chip platform, the glass-to-metal seals 932 also prevent leakage to the outside in the event that the other compartment is not rated for the pressures in the pipeline. Thus, the MEMS resonator chip side of the chip platform is commonly the high pressure side of the chip platform 930, in a first atmosphere, while the opposing side of the chip platform is a low pressure side, in a second atmosphere, thereby preventing mass transfer between the first and second atmospheres. The metallic post 929 can provide thermal contact between the temperature control device 112 and the MEMS resonator chip 2. The MEMS resonator chip 200 can be mounted on the metallic post 929 on the high-pressure side of the chip platform 930.

A first o-ring 936 is positioned on the high-pressure side of the chip platform 930, and a second o-ring 937 is positioned on opposing low-pressure side of the chip platform 930. The first and second o-rings 936 and 937 can substantially seal at least most, if not substantially all, of the high pressure on the high-pressure side of the chip platform 930. In this manner, the MEMS resonator chip 200 can be in contact with the high-pressure gas sample, while the opposing low-pressure side of the chip platform 930 can be substantially at about atmospheric pressure and isolated from the high-pressure gas sample. On the low-pressure side, the plurality of metallic pins 931 are soldered to the printed circuit board 925.

A wire bonded gold micro-wire 940 can connect a corresponding one of the plurality of metal pins 931 to the MEMS resonator chip 200. More specifically, the ground pads 1208, the input and output pads 1204 and 1200, and the temperature readout pads 1212 can be electrically connected by the wire bonded gold-micro wires 940 to the plurality of metal pins 931. In some configurations, the plurality of metal pins 931 can be gold coated on the high-pressure side of the chip platform 930. The plurality of metal pins 931 are gold coated to substantially one or both of abate corrosion and prepare the surface of the metal pins 931 for bonding of the gold micro-wires 940.

In order for the delicate MEMS resonator chip 200 not to be exposed fully during the parts replacement process, a protective mesh 945 is placed on top of the MEMS resonator chip 200 and its bonded gold-micro wires 940 for touch protection. The protective mesh 945 can be welded or soldered to the chip platform 935.

The MEMS resonator chip 200 can be protected from debris and contaminants by one or more porous and permeable plugs 948. The one or more plugs 948 can be porous fine and coarse sintered stainless steel sintered materials. Moreover, the one or more plugs 948 can allow gas molecules, including water in its gaseous form, to pass through the plugs 948, while blocking particulate contaminants and debris from reaching the MEMS resonator chip 200. Typically, the one or more plugs 948 are placed in the inlet 612 of the sensor compartment end cap 604. Generally, the one or more plugs 948a closest the outer opening of the inlet 612 has a larger pore size than the one or more plugs 948b closer the MEMS resonator chip 200. More generally, the one or more plugs 948 has a pore size in the micron range to block large entrained particles and the one or more plugs 948 nearer the MEMS resonator chip 200 has smaller pore size, typically from about 0.5 to about 1.0 μm. The smaller pore size plug 948b can block particles small enough pass through the plug 948a having micron size pores. However, the plug 948b can pass smaller nanoscale particles. Generally, the smaller nanoscale particles that can pass through the smaller pore size plug 948b are not harmful to the MEMS resonator chip 200 as their mass is negligible. Moreover, the nanoscale particles tend to keep entrained in the gas phase for a long time and are likely to deposit on the MEMS resonator chip 200, which, as noted, will not adversely impact MEMS resonator chip 200 performance.

During a three-month continuous forced flow test, a sintered element particle filter satisfactory blocked particles from reaching the MEMS resonator chip 200 The partial pressure changes in water vapor pressure on the two sides of the filters however ensures diffusion of water molecules through the filters maintaining the dew point on the resonator-chip side in equilibrium with the dew point of the gas at the inlet 612.

Furthermore, the one or more plugs 948 can act as a flame arrester. The flame arresting properties of the plugs 948 can contribute to the explosion proof certification of the dew point meter 100. The chip platform 930, the printed circuit board 925, and the MEMS resonator chip 200 can be replaced in the sensor head assembly as needed.

The dew point meter 100 can include a threaded terminal to be threaded into a gas pipe carrying a gas flow, with the gas passing through the plugs into the first compartment for sampling by the MEMS resonator chip 200 and associated circuitry.

### Dew Point Meter Control Module 116

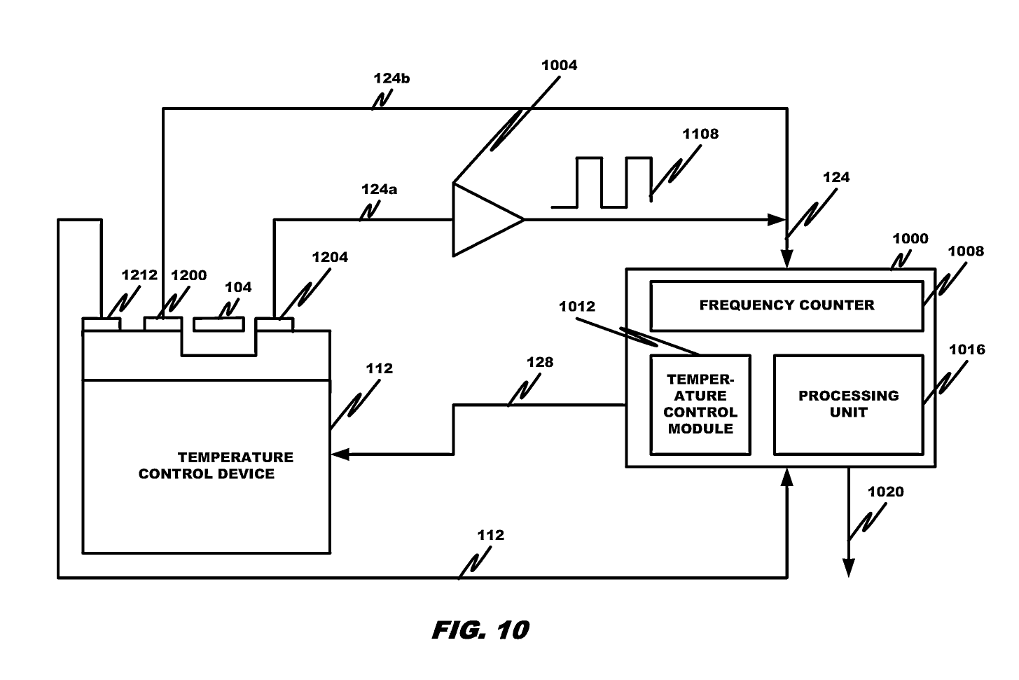

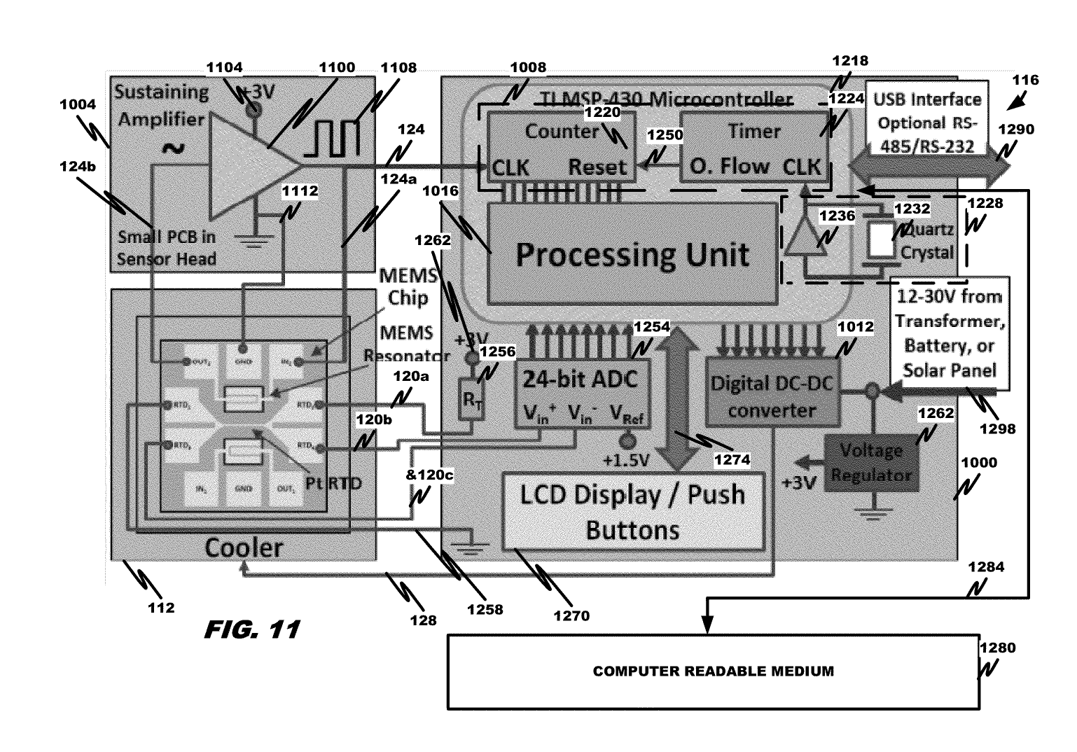

An embodiment of the dew point meter control module 116 is depicted in FIG. 10. The dew point control module 116 performs three primary functions in controlling the dew meter 100 and measuring dew point, namely monitoring the frequency of the MEMS resonator 104, monitoring the MEMS resonator temperature, and controlling the input power to the temperature control device 112. The dew point meter control module 116 includes a controller 1000 and a sustaining amplifier 1004 (or other type of device for monitoring MEMS resonator frequency, such as a network analyzer) electrically connected by leads 124a and b and 124 to the various conductive pads (FIG. 12) of the MEMS resonator 104 and by lead 128 to the temperature control device 112. The controller 1000, in turn, includes a frequency counter 1008 to determine an oscillation frequency (e.g., resonant frequency) of the MEMS resonator 104, a temperature control unit 1012 to control the temperature control device 112, and a processing unit (such as a microprocessor) 1016. The control module 116 further includes readout and control circuitry 1020 to a user interface (not shown).

These various components are shown in greater detail in FIGS. 11 and 12.

The sustaining amplifier 1004 includes an amplifier 1100 connected to a voltage source 1104 to produce a square wave 1108 having the same frequency as the MEMS resonator 104. The amplifier 1100 is connected by leads 124a and b to input and output pads 1204a and 1200a, respectively, of the first MEMS resonator 104a and by lead 1112 to a ground pad 1208a of the first MEMS resonator 104. Although not shown in FIG. 11, similar connections are made to input pad 1204b, output pad 1200b, and ground pad 1208b of the second MEMS resonator 104b.

Because the dew point meter 100 measures dew point based on frequency change of a MEMS resonator 104, the MEMS resonator 104 is inserted in a self-sustained oscillation loop. The MEMS resonator 104 is used as the time reference in the oscillator circuit. The MEMS resonator 104 is converted into an electronic oscillator by placing the MEMS resonator 104 in the feedback loop of the amplifier 1100 with an appropriate phase shift and adequate voltage gain. The voltage source 1104 compensates for energy losses in the oscillation loop so that the loop is self-sustained. To reduce self-heating, the voltage source typically provides only a few millivolts. The oscillator circuit of FIG. 11 generates an alternating output signal 1108 having the same frequency as the mechanical natural frequency of the MEMS resonator 104.

A microcontroller 1218 includes a counter 1220, timer 1224, and the processing unit 1016 and is in electrical communication with a system clock 1228 (which in turn includes a quartz crystal 1232 and an amplifier 1236), which provides a timing signal to the microcontroller 1218. A timing counter in the timer 1224 is triggered using the system clock 1228, that also provides timing signals to the other components of the microcontroller 1218, to track the elapsed time. For example, every time the timing counter overflows, an overflow bit 1250 can indicate the ending of one time interval and beginning of a new or next time interval. At the beginning of each time interval, the value of a resonator counter 1220 that is triggered by the output of the sustaining amplifier 1004 (or oscillator with MEMS resonator 104 as time reference) is read and recorded and the resonator counter 1220 is then reset to start counting in the new period. The value of the counter at the end of the time interval defined by the timing counter indicates the frequency of oscillations of the MEMS resonator. This makes the resonator or frequency counter circuitry very straight forward and results from the use, not of the absolute value of the resonator frequency, but rather of changes in the resonator frequency from one measurement period to the next to measure dew point. Therefore, the dew point meter 100 does not need to use a highly accurate external

clock to track the exact time elapsed in each time interval, as long as the time intervals are equal in duration. Temperature and long-term stability of the system clock 1228 is also generally not an issue as each dew-point measurement is performed in seconds and the number of triggers from the MEMS resonator in each time interval of a fraction of a second is compared to the number of triggers in similar time intervals before and after it.

The MEMS resonator temperature can be measured by any suitable technique, including a discrete thermocouple placed on the chilled surface next to the MEMS resonator. In some applications, a discrete thermocouple is not desirable because a thermocouple is a differential temperature detector and cannot directly measure the temperature of one point and a discrete element placed next to the MEMS resonator chip may not provide an accurate measure of the resonator temperature. To address these issues, resistance temperature detectors (RTD) (which are typically platinum) are integrated on the MEMS resonator chips to measure the temperature of the MEMS resonator(s). Platinum has a relatively large and linear temperature coefficient of resistivity and is therefore widely used for temperature detection. The integrated RTDs can be formed on top or next to the MEMS resonators on the chip. To achieve ultimate accuracy and eliminate the effect of any potential contact resistance, 4-wire measurement will be used to monitor resistance of the RTD, though any number of measurement wires may be employed.

The resistance measuring circuit is defined by RTD readout pads 1212b-d, which are connected by leads 120a-c to analog-to-digital (A/D) converter 1254, and RTD readout pad 1212a, which is connected by lead 1258 to ground. In operation, this configuration will typically be at a near constant current with a current-limiting resistor (R_{T}) 1256 in series with the RTD. The current will typically be in the range of a few tens of μA because higher currents, though giving more accuracy, cause self-heating error. The current will thus be set to minimize substantially the total error while maintaining self-heating at acceptable levels. As will be appreciated, the current is set by the resistance value of the current-limiting resistor 1256. This current produces a voltage that is measured by the (typically 24 bit) A/D converter 1254 (having a reference voltage V_{REF} of typically about 1.5 V). The voltage reference for the A/D converter 1254 comes from dividing a source voltage (which is typically 3V) provided by a resistive voltage divider 1262. This can create a proportional measurement where almost all measurement errors cancel. The current limiting resistor temperature coefficient is the major remaining, non-canceling error. The digital output of the converter 1254 is read and processed by the microcontroller 1218 to determine the MEMS resonator temperature.

Finally, the power input to the temperature control device 112 is controlled by the microcontroller 1218 depending on the measured resonator frequency and temperature. As will be appreciated, many different approaches can be employed. In one configuration, a single chip DC to DC converter 1012, with its voltage output value controlled by the microcontroller 1218 using a resistor array in the voltage feedback path can supply a specified voltage with currents ranging from a few milliamperes to a few amperes to the temperature control device 112. In another approach, pulse width modulation (PWM) is done by the microcontroller 1218 to control the effective voltage applied to the temperature control device 112. The desired pulse width generated at one of the output pins of the processing unit 1016 can be fed into a small power amplifier (not shown) and then applied to the temperature control device 112.

The user interface 1270 receives user input and provides output to the user and typically includes a liquid crystal display and tactile actuators, such as push buttons. A bus 1274 communicates user input and microcontroller 1218 output to the user via the user interface 1270.

The microcontroller 1218 is further in communication with an interface 1290 to external electrical components. In one configuration, the interface 1290 is a USB port that transmits commands to mass flow controllers. The outputs of the mass flow controllers can then be read by the microcontroller 1218.

Power input 1298 to the controller 1000 can be provided by any source. Typically, the power input ranges from about 12 to about 30 Volts provided by a transformer, battery, and/or solar panel.

The dew point meter control module 116 further includes a computer readable medium 1280 accessible by the microcontroller 1218 via bus 1284. The computer readable medium 1280 includes not only logic for the various operations controlled by the dew point meter control module 116 but also values for various default and measured parameters and dew point measurement data.

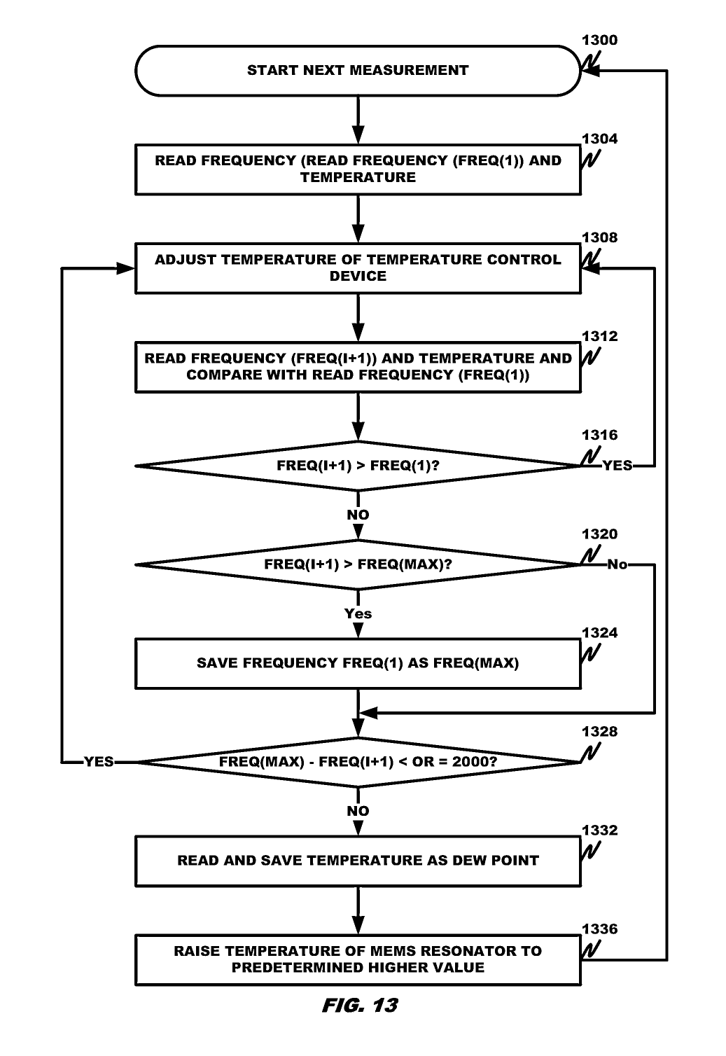

A first embodiment of control logic is shown in FIG. 13. The frequency and temperature of the MEMS resonator should be measured as frequently as possible, while the MEMS resonator temperature is being controlled by controlling the voltage applied to the temperature control device by the power supply.

In step 1300, a next measurement cycle is instantiated by the dew point meter control module 116, and, in step 1304, the processing unit reads the initial frequency FREQ(1) and the MEMS resonator temperature.

During the measurement cycle, an alternating voltage only, with a small amplitude, is applied to the actuation electrode of the MEMS resonator to excite its resonant mode. In response to the alternating voltage, a mechanical strain is generated within the resonator element, e.g. due to the piezoelectric effect. Accordingly an output signal, such as current or voltage, is generated at the sense electrode of the resonating element. The output signal will generally be very small due to the mechanical resistance against displacement. However, when the actuation voltage is at a mechanical natural frequency of the resonator, the amplitude of mechanical displacement and therefore the amount of electrical energy translated into mechanical strain is maximized resulting in a detectable output signal. The resonator output signal is amplified by the sustaining amplifier and fed back to the actuation electrodes after addition of the appropriate phase delays. Therefore, the sustaining amplifier forces the resonator to oscillate continuously at its desired mechanical natural frequency.

In step 1308, the processing unit adjusts the MEMS resonator temperature by sending appropriate signals to the temperature control device. In one application, the signals are selected to provide a substantially rate of cooling by the temperature control device of the MEMS resonator.

In step 1312, the processing unit reads the frequency FREQ(I+1) over the next time interval and the MEMS resonator temperature and compares FREQ(I+1) with the frequency FREQ(1).

In decision diamond 1316, the processing unit determines whether FREQ(I+1) is greater than FREQ(1). When FREQ(I+1) is greater than FREQ(1), the processing unit returns to and repeats step 1308. When FREQ(I+1) is not greater than FREQ(1), the processing unit proceeds to decision diamond 1320.

In decision diamond 1320, the processing unit determines whether FREQ(I+1) is greater than FREQ(MAX). When FREQ(I+1) is greater than FREQ(MAX), the processing unit proceeds to step 1324.

In step 1324, the processing unit saves FREQ(1) as FREQ(MAX).

After step 1324 or when FREQ(I+1) is not greater than FREQ(MAX), the processing unit, in decision diamond 1328, determines whether the difference of FREQ(MAX) and FREQ(I+1) is greater than or equal to some threshold value proportional to the resonant frequency.

When the difference is greater than or equal to 2000, the processing unit returns to and repeats step 1308.

When the difference is not greater than or equal to 2000, the processing unit, in step 1332, the processing unit reads and saves the MEMS resonator temperature as the dew point.

In next step 1336, the processing unit commands the temperature control device to raise the temperature of the MEMS resonator to a predetermined higher value.

As can be seen from the above process flow, this logic is designed to run cycle after cycle of dew-point measurements continuously. Each measurement cycle initially includes several iterations of a sub-cycle. Each sub-cycle includes frequency and temperature measurements followed by making a decision on the voltage applied to the temperature control device. The power input of the temperature control device is controlled using a simulated proportional-integral-derivative (PID) controller so that the temperature of the resonator keeps decreasing at a relatively constant rate. The MEMS resonator generally has a negative frequency temperature drift, i.e., its resonant frequency increases as the temperature decreases. The resonator frequency therefore increases first compared to its initial frequency when cooling starts. As will be evident from the subsequent steps, the logic measures the resonator frequency in each period and compares the resonator frequency to its frequency measured in the previous period, rather than the initial frequency. If the frequency drop in each period is significantly lower than the frequency in the previous period, while the resonator temperature has been reduced, it can be concluded that dew or frost point has reached. As soon as a very thin layer of dew or frost (as thin as a few angstroms) forms on the MEMS resonator surface, the added mass due to the layer of dew or frost lowers the resonator frequency significantly. Therefore, the resonator frequency will be at its highest level right when dew or frost starts to form, i.e., at the dew point.

The logic tracks the measured resonator frequencies in different subcycles and determines the temperature at which the frequency is maximized followed by a reliable consistent drop. As soon as a reliable drop in the frequency is detected after reaching the maximum frequency point, the measured temperature is recorded and reported as the dew point. After reaching the dew point, the temperature control device is turned off until the temperature of the resonator reaches a predetermined higher value, ensuring evaporation of the formed dew on the resonator, at which point a new measurement cycle starts.

The processor can remain dormant until the user or an external control system requires a new dew and/or frost point measurement.

The logic can be modified to minimize the time required for each measurement cycle, while maintaining a high level of accuracy. In this modification, the temperature control device can cool down the MEMS resonator at a high rate and lower the cooling rate as soon as the MEMS resonator frequency changes from a previous sub-cycle starts to slow down indicating that the dew point temperature measurement is temporally close. In this manner, the overall time required for each measurement cycle can be reduced without sacrificing the temperature control and monitoring accuracy.

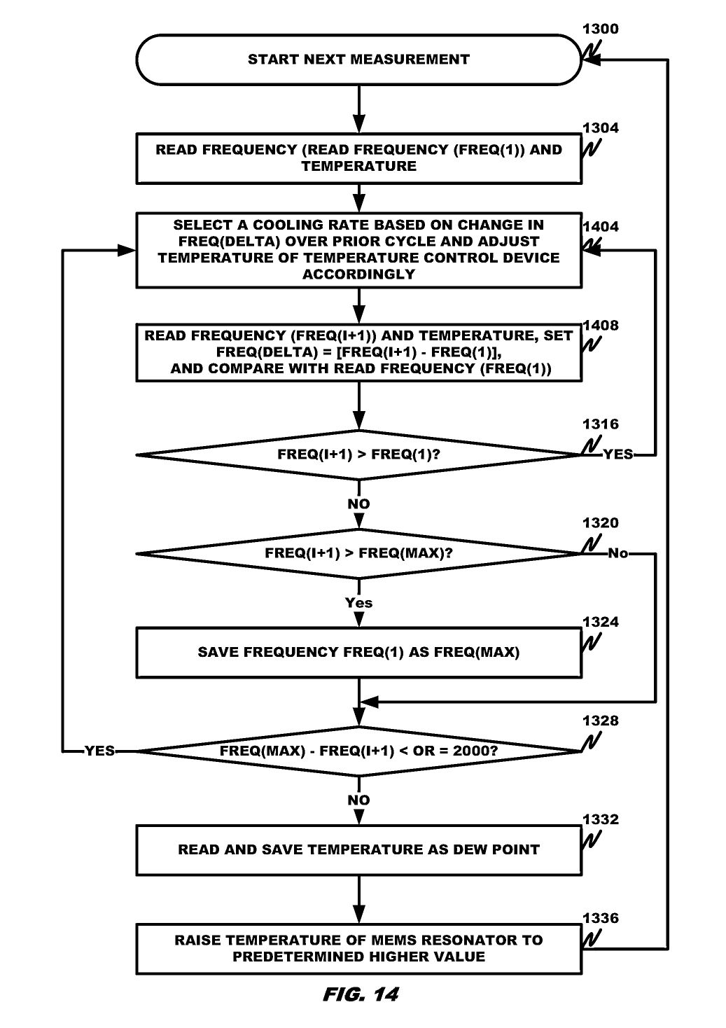

This modified logic is shown in FIG. 14. As can be seen from the steps, the primary differences between the modified logic and logic of FIG. 13 are steps 1404 and 1408. In step 1404, the processing unit selects a cooling rate for the MEMS resonator based on a change in FREQ(DELTA) over its value in the prior cycle and adjusts the MEMS resonator temperature by sending appropriate signals to the temperature control device. In step 1408, the processing unit reads the frequency FREQ(I+1) and MEMS resonator temperature over the next time interval, sets FREQ(DELTA) equal to FREQ(I+1)−FREQ(1), and compares with the frequency FREQ(1).

Either logic can be operated in a continuous mode, where upon reaching the dew and/or frost point, the temperature of the MEMS resonator is controlled so that it maintains the same deposited dew and/or frost thickness on its surface. The measured temperatures under this condition would be a continuous measure of dew or frost point.

Alternatively, logic can be operated in a semi-continuous mode, where upon reaching the dew and/or frost point, the temperature of the resonator is slightly increased just to remove the formed dew and/or frost partially or completely. Right after partial or complete removal of the dew and/or frost, the temperature is reduced again to record another dew and/or frost point measurement.

### EXPERIMENTAL

The following examples are provided to illustrate certain aspects, embodiments, and configurations of the disclosure and are not to be construed as limitations on the disclosure, as set forth in the appended claims. All parts and percentages are by weight unless otherwise specified.

A test setup capable of accurate parameter control for dew and/or frost point generation and automated sensor data collection was built. This allowed collection of quantitative data over long periods of time to study long term stability and reliability of the disclosed sensors. Accelerated tests were performed on the sensors running up to 1000 measurement cycles per day. Addressing this objective was divided into the following three tasks, all of which have been addressed in the implemented test setup.

The setup included three major sections: a) custom-made dew and/or frost point generator capable of outputting air with programmed dew points ranging from −45° C. to +20° C.; b) dew point meter including the cooling unit, a microelerctromechanical system (MEMS) sensor, and a rapid-prototyped housing; and c) measurement and control devices interfaced with the LabVIEW program running on a personal computer (PC).

A dew and/or frost point generator setup, including a dry air source (i.e., a compressed dry air generator), a saturator, and two electronically controlled mass flow controllers (MFC's), was developed to control precisely wet and dry air flows and therefore humidity level (dew point) in the output gas. The digital MFC's had the appropriate flow ratings used for controlling wet and dry air flows and, along with an air compressor and air dryer module used in the dew and/or frost point generator setup, allowed accurate generation of dew points down to −45° C. The two MFC's, two power supplies, a network analyzer, and a temperature sensor were interfaced with a LabVIEW computer program devised to perform continuously running long-term tests and automated data collection.

The compressor first pressurizes room air to 90-120 psi. (Although pressurizing the room air causes condensation of some of the moisture in the air, the compressor output provides dry air.) The dew and/or frost point of the output air was determined to be in the range −5 to −10° C. depending on the room temperature and pressure in the compressor chamber. This was not nearly dry enough to perform the low dew-point determinations targeted in this demonstration. A Balston MEMSbrane air dryer was therefore added to the output of the compressor. The air dryer is capable of drying the compressed air to dew and/or frost point of −50° C. The dry air was then split between two different paths. One path went directly to an MFC with a higher flow rating (500 sccm full-scale), while the other path directed the dry air to a saturator. The saturator was comprised of two 1-inch diameter transparent PVC pipes. The pipes were connected by a stainless steel tube on the bottom and were partially filled with water. The compressed dry air entered the first pipe and bubbled through the water in the second pipe using a regular aquarium air stone. The small bubbles of air absorbed water on their way and became saturated with water as they left the second pipe. The output of the saturator was fed into a second digital MFC with lower flow rating (50 sccm full-scale). The output of the two MFC's were mixed in a T-connection and fed to the sensor head where the MEMS resonator was located. The flow of each MFC could be controlled by a computer program from 3% to 100% of its full-scale, enabling a wide range of moisture contents in the output gas.

The main component in the test setup performing the dew and/or frost point determinations was the sensor head comprised of a MEMS resonator mounted on a cooler platform with a path for the sample air to flow over the resonator. A five stage Peltier cooler assembled on top of a single stage Peltier assembly, including a heat sink and fan on its bottom side, along with the efficient rapid-prototypes dew point meter, was utilized to allow reaching temperatures as low as −65° C. A MEMS resonator chip was mounted on the top surface of the 5-stage cooler. All mountings were done using a thermally conductive paste. The cooler was covered with two of the rapid prototyped plastic pieces. The plastic covers provided thermal insulation between the lower cooler stages and the surrounding environment minimizing the cooling power required for achieving lower temperatures on the resonator chip. The plastic covers also provided a flat surface for mounting the printed circuit board that provides electrical connections and components required for operation of the MEMS resonator. Finally, the sensor cap that also served as a mini-container for the sample gas under test was placed on top of the whole assembly. The cap had a tapped hole on one side where a Swagelok fitting could be threaded in. The hole also provided a pathway to the mini-container under the cap delivering the output of the dew-point generator to the resonator under the cap. The dew point meter was connected to the gas flow output from the dew-point generator along with electrical connections to the embedded printed circuit board (PCB) for operating the MEMS resonator. To monitor the temperature of the resonator chip, the thin wire thermocouple was placed on the cooler platform next to the resonator chip before placing the sensor cap in its place. Bolts reaching all the way down and threading into the cooler assembly held the PCB and the cap in their position.

To control the dew-point generator and collect dew-point determination data from the sensor head, LabVIEW programs were developed. Controlling the dew-point generator only required manually entering the flow values into the two MFC's. A computer USB port and a USB to RS-485 converter were used to transmit the commands to the MFCs and read their outputs through their RS-485 ports.

The LabVIEW program ran cycle after cycle of dew-point determinations continuously. Each measurement cycle initially includes several iterations of a sub-cycle. Each sub-cycle includes frequency and temperature determinations followed by making a decision on the voltage applied to the cooler. The power input of the Peltier cooler is controlled using a simulated proportional-integral-derivative (PID) controller so that the temperature of the resonator keeps decreasing at a relatively constant rate. The MEMS resonators used in this work have negative frequency temperature drift, i.e. their resonant frequency increases as the temperature decreases. As soon as a very thin layer of dew or frost (as thin as a few angstroms) forms on the resonator surface, the added mass due to the layer of dew or frost lowers the resonator frequency significantly. Therefore, the MEMS resonator frequency will be at its highest level right when dew or frost starts to form, i.e. at the dew point. The program keeps track of determined resonator frequencies in different sub-cycles and determines the temperature at which the frequency is maximized followed by a reliable consistent drop. As soon as a reliable drop in the frequency is detected after reaching the maximum frequency point, the determined temperature is recorded and reported as the dew point.

The frequency and temperature of the MEMS resonator needed to be determined as frequently as possible, while the temperature was being controlled by controlling the voltage applied to the 5-stage Peltier cooler by a power supply. A K-type thermocouple with very fine wires (0.4 mm diameter) along with a USB thermocouple reader from National Instruments was used to monitor the temperature of the resonator chip. An Agilent™ network analyzer was used to monitor the resonant frequency of the resonator. The network analyzer determines and graphs the frequency response of the resonator in a small frequency range around its center frequency (˜25 MHz in this case). The network analyzer can be programmed to detect the peak frequency in the frequency response graph, which indicates the resonant frequency of the resonator. An Agilent™ digital power supply was used to provide and control the power input to the Peltier cooler. The power supply and network analyzer were interfaced with the LabVIEW program via GPIB cables connected to another USB port of the computer through a USB to GPIB converter.

After reaching the dew point, the cooler is turned off until the temperature of the resonator reaches a pre-set higher value, ensuring evaporation of the formed dew on the resonator, at which point a new measurement cycle starts.

Robustness of electrical connections was determined. It is generally difficult to make robust electrical connections to MEMS device. A specifically designed test circuit board was used to implement and characterize metal-to-metal connections for the MEMS resonator chip. The test circuit board included a chip holder from the backside into the recessed area in the PCB. The chip holder places the chip within the open area on the PCB front side and the gold pads on the micro-chip in contact with the metal pins soldered to the PCB. The chip holder is then fixed to the PCB using small bolts. The spacing between the metal pads on the micro-chip and the metal tracks on the PCB, as well as their location with respect to the edges of the micro-chip/PCB were carefully chosen to be compatible. In this manner, after the assembly, the gold-coated soldered metal pins automatically end up in their desired locations on the metal pads on the micro-chip. The microchip was 4×8 mm², and metal pads on the micro-chip are 00˜800 μm².

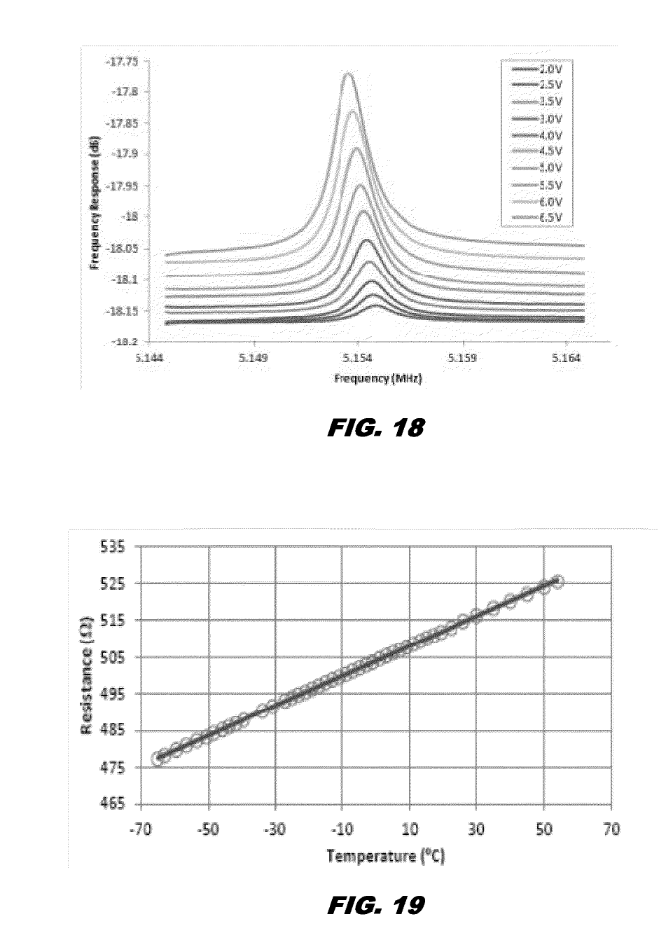

To test the stability and quality of the signals provided by the metal to metal connections formed via the described procedure, frequency response of a thermal-piezoresistive resonator with such connections was measured and recorded using a Network Analyzer (FIG. 18). Electrical signals were transferred from the PCB to the network analyzer using regular coaxial cables. FIG. 18 also shows the measured frequency response of the thermally actuated resonant structure for different bias voltages.

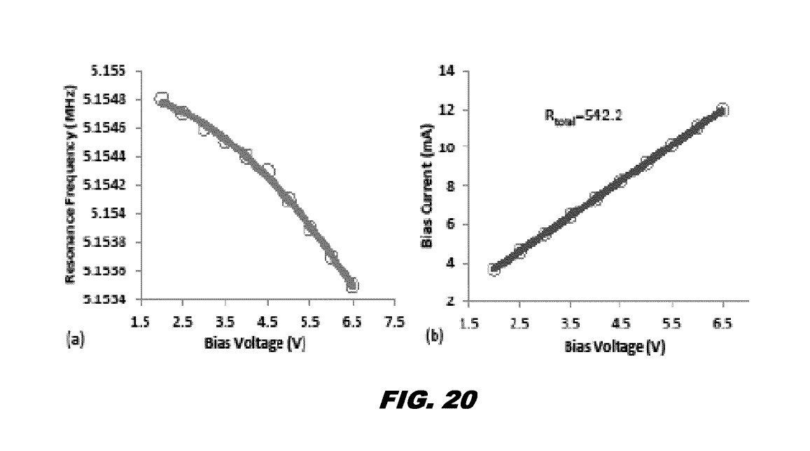

FIG. 20 graphs the measured resonance frequency and bias current of the same resonator for different bias voltages. The frequency-bias voltage behavior (FIG. 20a) is in very good agreement with the results obtained using typical wire-bonded connections to the MEMS resonators showing a decrease in resonant frequency as the bias voltage increases raising the temperature of the resonator. FIG. 20b shows the measured bias current through the resonator as a function of the applied DC bias voltage showing a linear resistive behavior for the series combination of the resonator and its external bias resistor. The series combination acts as a perfect linear resistor (Rₜₒₜₐₗ=542.2 ohm), which demonstrates the promising performance of the metallic connections without introducing a measurable amount of contact resistance. With the value of the series bias resistor being 470 ohm, the resistance of the resonator is calculated to be 72.2 ohm, which is within the expected range.

A few of the fabricated integrated platinum RTDs were characterized. FIG. 19 shows the measured resistance, using a 4-connection measurement, values in ohms for a fabricated platinum micro-resistance temperature detector over the temperature range of about −65 to about +55 degrees Celsius, the response was substantially linear, with a slope of 800 ppm per degree Celsius. It is noted that the measured change in resistance is about four times smaller than the well-known shift for a platinum resistor. The source of such discrepancy is unknown, but be due to the quality of the deposited platinum film or thermal stresses resulting from the material mismatches in the fabricated devices Annealing of the deposited platinum films can lead to refining of the metal grains and grain boundaries leading to a closer to expected response. On the other hand, thermal stress could lead to changes in the electrical resistance of the metal due to the piezoresistive effect. As long as the fabricated resistive temperature detectors maintain the same performance over time, such discrepancy between expected and measured results would not be a problem, as the temperature sensitivity is sufficiently large.

The piezoelectric MEMS resonators used as replacement for the failing thermal-piezoresistive resonators proved to be surprisingly robust and durable. A first MEMS resonator used in the dew point meter performed over 35,000 dew point measurements in a long-term accelerated test that took over two months and was still operating flawlessly. The first resonator was removed from the test setup only to put a second MEMS resonator having a different electrical design in place. The second resonator ran for over 10,000 dew point measurement cycles and was still operating flawlessly when removed some time later.

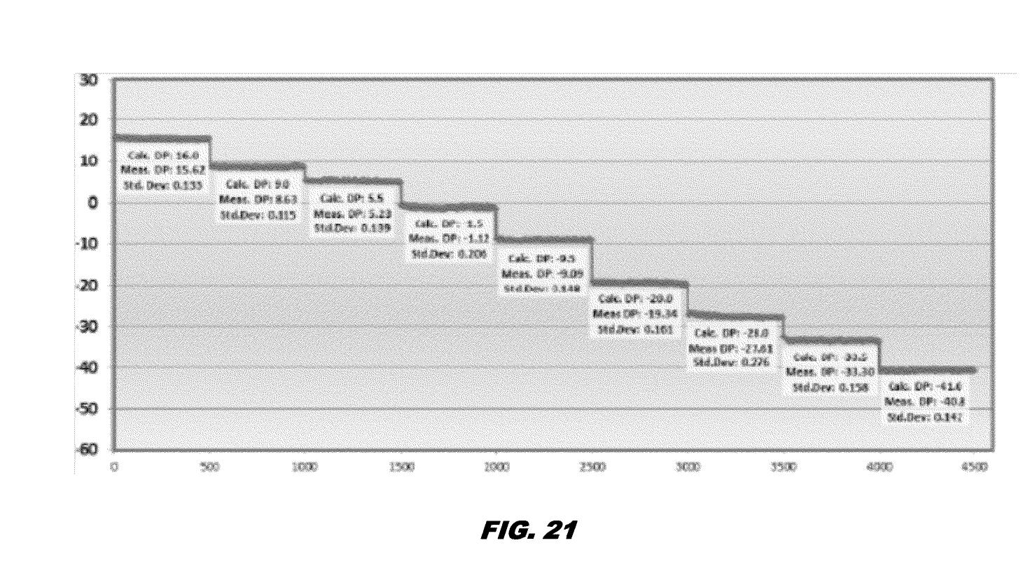

FIG. 21 shows 4,500 dew point measurement results performed using the second MEMS resonator. Each set of 500 points has been taken at a certain humidity level setting on the dew-point generator and by running the test setup unattended overnight. The calculated dew point setting for different sets ranges from 16° C. to −41° C. The results are presented in the table:

TABLE 1
Dew point generator settings and calculated dew point along with measured average
dew point and standard deviation for each of the 500 measurement sets.

| Dry | Wet | Saturator | | H₂O Vapor | | Average | Meas. D.P. Std. |
|---|---|---|---|---|---|---|---|
| Flow % | Flow % | Pressure | ppmV | Pressure | Calculated | Measured | Dev. (500 points) |
| F.S. | F.S. | (psi) | H₂O | (Torr) | D.P. (° C.) | D.P. (° C.) | (° C.) |
| 0 | 100 | 8 | 17900 | 13.6 | 16 | 15.62 | 0.133 |
| 0 | 100 | 20 | 11300 | 8.60 | 9 | 8.63 | 0.114 |
| 3 | 100 | 24.5 | 7500 | 6.82 | 5.5 | 5.24 | 0.139 |
| 6 | 50 | 24.5 | 5100 | 4.06 | −1.5 | −1.12 | 0.206 |
| 8 | 25 | 24.5 | 2300 | 2.05 | −9.5 | −9.10 | 0.148 |
| 32 | 80 | 49 | 1200 | 0.776 | −20 | −19.35 | 0.161 |
| 36 | 40 | 49 | 570 | 0.351 | −28 | −27.61 | 0.276 |
| 38 | 20 | 49 | 280 | 0.195 | −33.5 | −33.30 | 0.158 |
| 39 | 10 | 49 | 145 | 0.086 | −41 | −40.81 | 0.142 |

Table 1 shows the dew point generator settings and calculated (expected) dew-points from such settings along with measured average dew point and average and standard deviation for each set of 500 measured data points. The measured averages closely follow the expected dew points based on the set dry air and saturated air flows as well as the saturator pressure in the dew-point generator. Small discrepancies of less than 0.5° C. between the measured average and expected values are likely to be due to measurement errors, room temperature variations and rounding errors. Standard deviation in the measured data ranges from 0.115° C. to 0.276° C., showing great consistency in the data points measured under the same dew point generator settings. Furthermore, the major source of deviation in the data can be external factors such as changes in room temperature overnight.

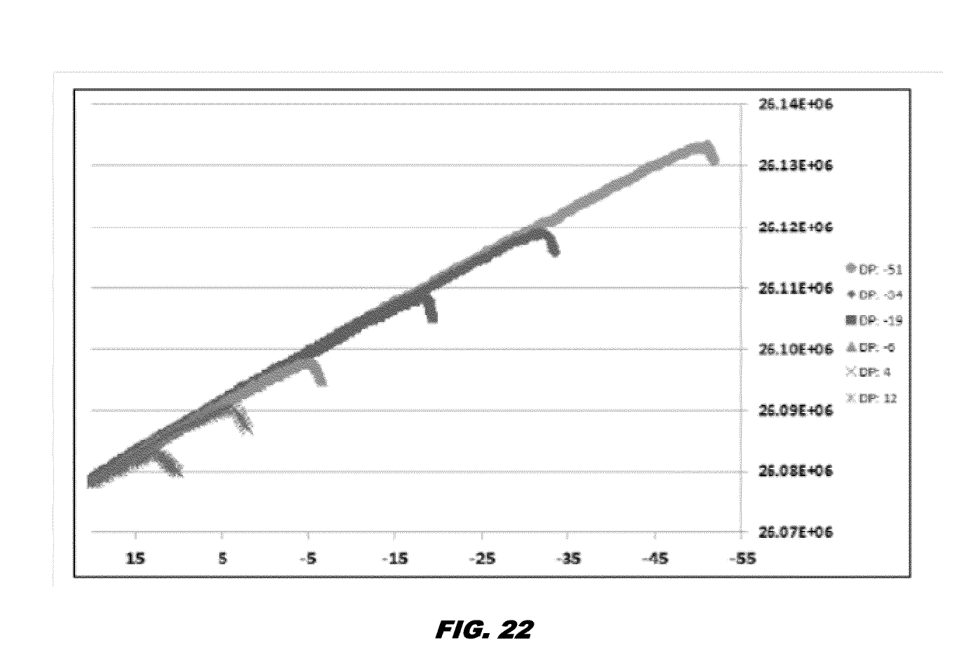

FIG. 22 shows frequency versus temperature measurement data for the MEMS resonator in the dew point meter subject to air flows with different moisture content. As expected, due to the negative temperature coefficient of frequency for the resonators, initially as the resonator cools down its resonant frequency increases until the temperature reaches the dew point of the surrounding gas and dew or frost starts forming on the resonator surface. The resonator frequency drops sharply as soon as a thin (a few nanometers thick) layer of dew or frost is formed. Even at very low moisture levels, the frost formation is quite rapid for the ultra-high sensitivity of the micro-resonator enabling accurate and fast measurement of the frost formation temperature.

One potential issue encountered during the testing was the inability of the initially planned thermal-piezoresistive MEMS resonators to operate as reliably as needed. The problem was diagnosed as self-heating and galvanic corrosion due to the DC bias required for operation of such devices. The problem was addressed by utilizing piezoelectric MEMS resonators that require little or no DC bias for operation and generate almost no heat during operation. A few problems were encountered during the micro-fabrication process development, mainly caused by poor adhesion of platinum thin films, that were addressed via minor adjustments in the device layout and process recipes. Other minor problems encountered were fixed relatively easily by making changes to the software, mechanical adjustments, or using more advanced tools.

In summary, the measured dew point values were found to be consistent and in good agreement with the predicted values based on the dew point generator settings. Dew points over a wide range of 16° C. (17,900 ppmV) to −41° C. (115 ppmV) were successfully and accurately measured by the test setup. The MEMS resonant mass balances were found to be surprisingly robust. Accelerated tests were performed on two resonators running continuously for an overall period of over 3 months performing over 50,000 measurement cycles without showing any sign of fatigue or performance degradation, thereby enabling unattended accelerated operation. The MEMS resonator exhibited flawless operation over more than 35,000 measurement cycles (and was still working when the tests were terminated). Cumulatively, these cycles are equivalent to one to ten years of operation in a typical application depending on how frequently dew point in a natural gas pipeline is to be measured and reported.

Increased pressure on resonator was expected to cause viscous damping of the resonator vibrations. The viscous damping decreases accuracy in resonator frequency measurements and weakens the output signal amplitude. Therefore, resonator performance was determined under high pressure. The resonator was mounted in a chamber designed to tolerate pressures up to 300 psi. Tests were performed by connecting the input of the chamber to a high pressure nitrogen tank while measuring the resonator response. The tests were however performed up to 112.5 psi absolute pressure (100 psi reading on the regulator). The measured resonator quality factors (i.e., accuracy of resonator frequency measurement and strength of output signal amplitude, large quality factor indicates highly accurate frequency measurement and strong output signal amplitude) under high pressure also showed a desirable trend making tests at higher pressure almost unnecessary. As shown in FIG. 17, as the chamber pressure increases the resonator quality factor initially drops relatively sharply, but the rate of drop slows down as the pressure increases. It is expected that resonator quality factor reaches about 1,000 at pressures at about 500 psi. Quality factors as low as a few hundred are more than enough for accurate reading of the resonator frequency. Even quality factors below 100 can be satisfactory for resonators having low motional impedance. Piezoelectric resonators are a non-limiting example of low motional impedance resonators.

A number of variations and modifications of the disclosure can be used. It would be possible to provide for some features of the disclosure without providing others.

For example in one alternative embodiment, other types of resonators are used in place of the (typically bulk mode) piezoelectric MEMS resonator discussed above. Examples include other classes of MEMS resonators, such as thermal-piezoresistive resonators, capacitive resonators, and piezoelectric resonators. Other devices, such as suspended cantilevers, can operate as capacitive resonators with narrow air gaps between electrodes and resonating body along with a DC bias voltage for actuation and sensing. While many of these devices can provide good resonance responses, the electrostatic field from the DC bias can lead to corrosion and therefore contamination or destruction of the resonating element in contact with gases and dew or frost, rendering it incapable of operating reliably over a long period of time. The narrow air-gap also makes the resonator highly vulnerable to contaminants potentially clogging the gap and blocking resonator vibrations.

In yet another embodiment, the resonator can have both bulk mode and flexural mode oscillations.

In another alternative embodiment, a network analyzer is used to monitor the resonant frequency of the resonator. The network analyzer measures and graphs the frequency response of the resonator in a small frequency range around its center frequency (−25 MHz in this case). The network analyzer can be programmed to detect the peak frequency in the frequency response graph, which indicates the resonant frequency of the resonator.

In yet another embodiment, the determination of a dew point is not limited to the detection of water vapor in air. Any gas which can be condensed from any mixture of gases to form a liquid or a solid under the temperature and pressure conditions that exist within the operational parameters of the disclosed device can be detected by this method and device.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A dew and/or frost point measurement instrument, comprising:
an electrically actuated at least one of micro- and nanoscale resonating element formed over a resonator substrate;
a temperature control device in thermal communication with the resonator substrate to provide a cooled surface for formation of dew and/or frost;
a temperature sensing element in thermal communication with the resonating element to sense a temperature of the cooled surface;
a sustaining amplifier for stimulating the resonating element to maintain substantially continuous oscillations at a mechanical natural frequency and output a waveform proportional to the mechanical natural frequency;
a control circuitry to monitor a frequency of the resonating element, to control the temperature of the cooled surface in response to the monitored frequency, and, based on the temperature of the cooled surface and monitored frequency, to determine a dew or frost point of a gaseous compound of interest.

2. The instrument according to claim 1, wherein the resonator is stimulated by an alternating voltage only at its mechanical resonant frequency, wherein the resonating element comprises a piezoelectric film, and wherein the voltage is applied across the piezoelectric film.

3. The instrument according to claim 1, wherein the temperature sensing element is integrated on the resonator substrate and wherein a direct current voltage is not applied to the resonating element.

4. The instrument according to claim 1, wherein the temperature sensing element comprises a resistive temperature detector, the resistive temperature detector comprising a metallic thin film deposited on a substrate and wherein the resonating element is substantially free of flexural deformation when oscillating.

5. The instrument according to claim 1, wherein the resonating element comprises a doubly clamped structure resonating in its bulk mode and wherein the resonating element is a bulk mode resonator and not a flexural mode resonator.

6. The instrument according to claim 1, wherein the resonating element comprises a piezoelectric thin film sandwiched between two conductive layers and wherein the sustaining amplifier is integral with the resonating element.

7. The instrument according to claim 1, wherein the resonating element uses multiple electrically isolated conductive electrodes for actuating oscillations of the resonating element and sensing of its resonance.

8. The instrument according to claim 1, wherein the temperature control element comprises a thermoelectric cooler/heater.

9. The instrument according to claim 1, wherein the oscillation frequency of the resonating element is measured using a digital counter with a precisely timed gate.

10. The instrument according to claim 1, further comprising a battery in electrical communication with the resonating element and control circuitry, whereby the battery enables wireless operation.

11. The instrument according to claim 1, further comprising a solar panel coupled to a rechargeable battery in electrical communication with the resonating element and control circuitry, whereby the solar panel enables wireless operation.

12. The instrument according to claim 1, further comprising a porous protective layer disposed over the resonator to block particulate and contaminants from reaching the resonator.

13. The instrument according to claim 1 embodied in a sensor head having a threaded terminal for engagement with a pressurized gas line.

14. The instrument according to claim 1, further comprising bonded micro-wires providing electrical contacts between metallic pins and electrical signal pads formed over the resonator substrate.

15. The instrument according to claim 1 embodied in a sensor head having a metallic mount for thermally coupling the resonating element with a cooling/heating element.

16. The instrument according to claim 1 embodied in a sensor head having a sealed metallic plate with electrically insulated metallic feedthroughs.

17. A method, comprising:
cooling a bulk mode resonating element, in the presence of a gas sample, while monitoring an oscillation frequency and temperature of the resonating element until a thin layer of dew or frost is formed on the resonating element, wherein a reduction in the oscillation frequency of the resonating element signals formation of a dew or frost; and
when the reduction in oscillation frequency occurs, sensing a temperature of the resonating element as a dew or frost point of a gas sample.

18. The method according to claim 17, wherein the resonator frequency increases as the resonating element is cooled until the dew or frost is formed, wherein the oscillation frequency is a resonant frequency of the resonating element, and wherein the resonating element is substantially free of flexural deformation when oscillating.

19. The method according to claim 17, further comprising terminating the cooling after detection of the dew or frost.

20. The method according to claim 17, further comprising reducing a cooling power of the cooling after formation of the dew or frost to remove the dew or frost and wherein a direct current voltage is not applied to the resonating element.

21. The method according to claim 17, further comprising controlling the cooling after detection of the dew or frost to maintain a predetermined thickness of dew or frost on a surface of the resonating element.

22. The method according to claim 17, further comprising recording a maximum resonator frequency before the abrupt reduction to define a reference point for dew or frost thickness, or for temperature estimation.

23. The method according to claim 17, wherein the wherein the bulk mode resonating element comprises a piezoelectric thin film sandwiched between two conductive layers.

24. A tangible and nontransient computer readable medium comprising microprocessor executable instructions that, when executed by the microprocessor, perform the steps of claim 17.

25. An assembly comprising:
a micro-chip, comprising:
a chip body having a chip void, a output pad, and input pad; and
a bulk mode resonator positioned in the chip void, the resonator comprising:
an actuation electrode;
a sense electrode, wherein the actuation and sense electrodes are interdigitated;
a piezoelectric material in electrical communication with the actuation and sense electrodes;
an output lead electrically interconnected to the actuation electrode and the output pad; and
an input lead electrically connected to the sense electrode and the input pad; and
a temperature control device in thermal communication with the microchip to adjust a temperature of the microchip when the microchip is oscillating.

26. The assembly of claim 25, wherein the resonator is a piezoelectric resonator, wherein the sense and actuation electrodes comprise gold or platinum; wherein the resonator and chip body comprise a metal layer positioned between an aluminum nitride layer and a silicon substrate, and wherein the sense and actuation electrodes are positioned on the aluminum nitride layer.
